(19) United States
(12) Patent Application Publication
(10) Pub. No.: US 2025/0254729 A1
(43) Pub. Date: Aug. 7, 2025

(54) Latency Sensitive Traffic Transmission

(71) Applicant: Ofinno, LLC, Reston, VA (US)

(72) Inventors: Jeongki Kim, Fairfax, VA (US); Leonardo Alisasis Lanante, Reston, VA (US); Esmael Hejazi Dinan, McLean, VA (US)

(73) Assignee: Ofinno, LLC, Reston, VA (US)

(21) Appl. No.: 19/191,081

(22) Filed: Apr. 28, 2025

Related U.S. Application Data
(63) Continuation of application No. PCT/US2023/036227, filed on Oct. 30, 2023.
(60) Provisional application No. 63/420,737, filed on Oct. 31, 2022.

(51) Int. Cl. H04W 74/0816; H04W 84/12

(52) U.S. Cl. CPC H04W 74/0816; H04W 84/12

(57) ABSTRACT

A station (STA) receives, via a channel, an overlapping basic service set (OBSS) physical layer protocol data unit (PPDU) comprising an indication of whether the OBSS PPDU contains latency sensitive (LS) traffic or whether pre-emption of the OBSS PPDU is allowed. The STA accesses the channel, to transmit a PPDU, based on the indication. Accessing the channel to transmit the PPDU based on the first indication may comprise accessing the channel to transmit the PPDU without consideration of overlap of the PPDU with the OBSS PPDU, based on the indication indicating that the OBSS PPDU does not contain LS traffic or that pre-emption of the OBSS PPDU is allowed.

### CROSS-REFERENCE TO RELATED APPLICATIONS

This application is a continuation of International Application No. PCT/US2023/036227, filed Oct. 30, 2023, which claims the benefit of U.S. Provisional Application No. 63/420,737, filed Oct. 31, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QOS) null frame indicating buffer status information.

FIG. 5 illustrates an example format of a physical layer (PHY) protocol data unit (PPDU).

FIG. 6 illustrates an example that includes buffer status reporting by STAs, scheduling by an AP of uplink multi-user (MU) transmissions, and transmission of scheduled uplink transmissions by the STAs.

FIG. 7 illustrates an example of a trigger frame format.

FIG. 8 is an example that illustrates an existing operation mode which may be used by a STA to transmit a frame in the presence of an Overlapping Basic Service Set (OBSS) transmission.

FIG. 9 is an example that illustrates another existing operation mode which may be used by a STA in the presence of an OBSS transmission.

FIG. 10 is an example that illustrates an example interference outcome that may result from the use of the existing operation mode illustrated in FIG. 9

FIG. 11 is an example that illustrates another example interference outcome that may result from the use of the existing operation mode illustrated in FIG. 9.

FIG. 12 is an example that illustrates a problem that may result from the use of the existing operation mode illustrated in FIG. 9

FIG. 13 is an example that illustrates an example operation mode which may be used by a STA in the presence of an OBSS transmission according to an embodiment.

FIG. 14 is an example that illustrates another example operation mode which may be used by a STA in the presence of an OBSS transmission according to an embodiment.

FIG. 15 illustrates an example physical layer (PHY) protocol data unit (PPDU) which may be used to support the example operation modes illustrated in FIGS. 13 and 14.

FIG. 16 is an example that illustrates another example operation mode which may be used by a STA in the presence of an OBSS transmission according to an embodiment.

FIG. 17 is an example that illustrates another example operation mode which may be used by a STA in the presence of an OBSS transmission according to an embodiment.

FIG. 18 illustrates example MAC header signaling which may be used to support the example operation modes illustrated in FIGS. 16 and 17.

FIG. 19 is an example that illustrates another example operation mode which may be used by a STA in the presence of an OBSS transmission according to an embodiment.

FIG. 20 illustrates an example PPDU which may be used to support the example operation mode illustrated in FIG. 19.

FIG. 21 is an example that illustrates another example operation which may be used by a STA in the presence of an OBSS transmission according to an embodiment.

FIG. 22 illustrates example MAC header signaling which may be used to support the example operation mode illustrated in FIG. 21.

FIG. 23 is an example that illustrates another example operation mode which may be used by a STA in the presence of an OBSS transmission according to an embodiment.

FIG. 24 illustrates an example process according to an embodiment.

FIG. 25 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

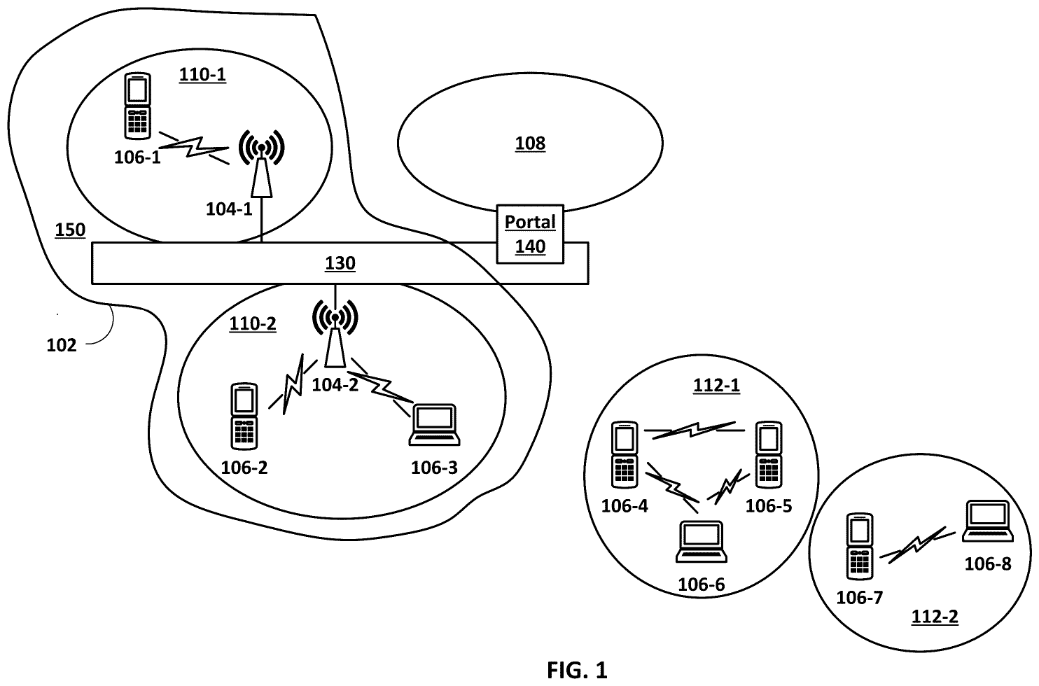

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHZ. Larger channels may be formed through channel bonding. For example, PPDUs may be transmitted over physical channels having bandwidths of 40 MHZ, 80 MHz, 160 MHz, or 320 MHz by bonding together multiple 20 MHz channels.

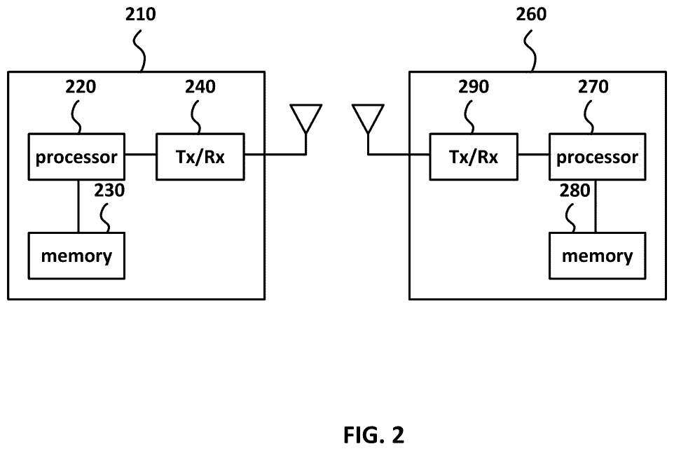

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

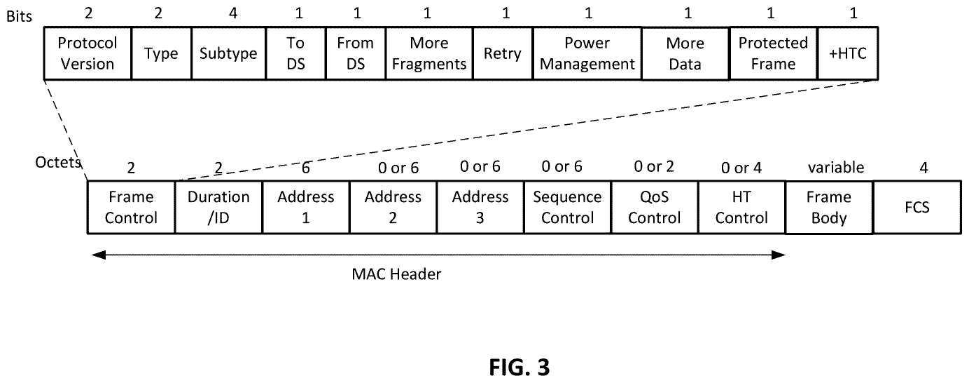

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control fields include the following subfields: protocol version, type, subtype, To DS, From DS, more fragments, retry, power management, more data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contain no frame body field.

The To DS subfield indicates whether a data frame is destined to the distribution system (DS). The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (Bus) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the MAC frame format. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

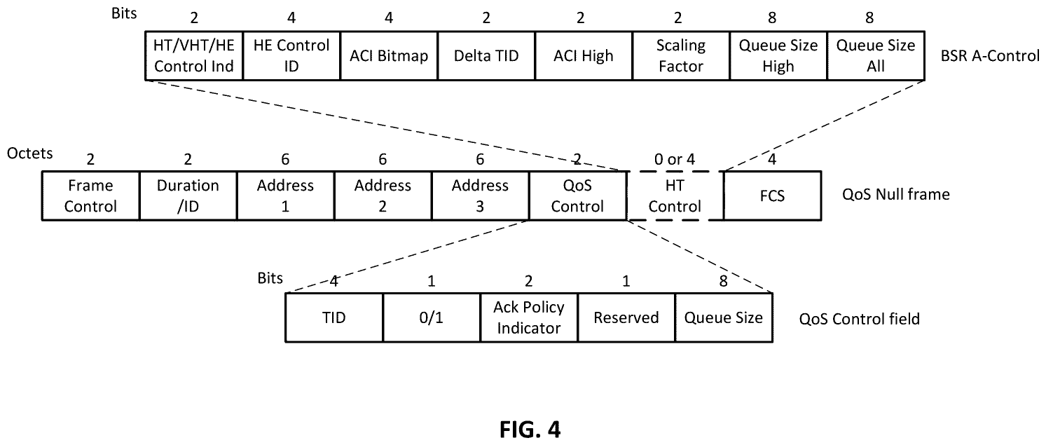

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:

The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.

A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, on.

A STA obtains the queue size, QS, from a received QoS control field, which contains a scaling factor, SF, and an unscaled value, UV, as follows:

### QS=

16×UV, if SF is equal to 0;
1024+256× UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for uplink (UL) multi-user (MU) operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all Acs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

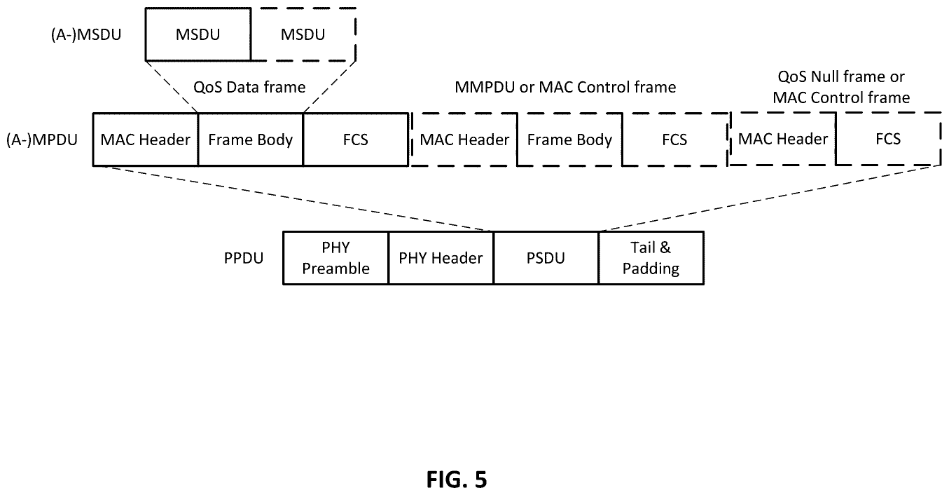

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An aggregate MPDU (A-MPDU) may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

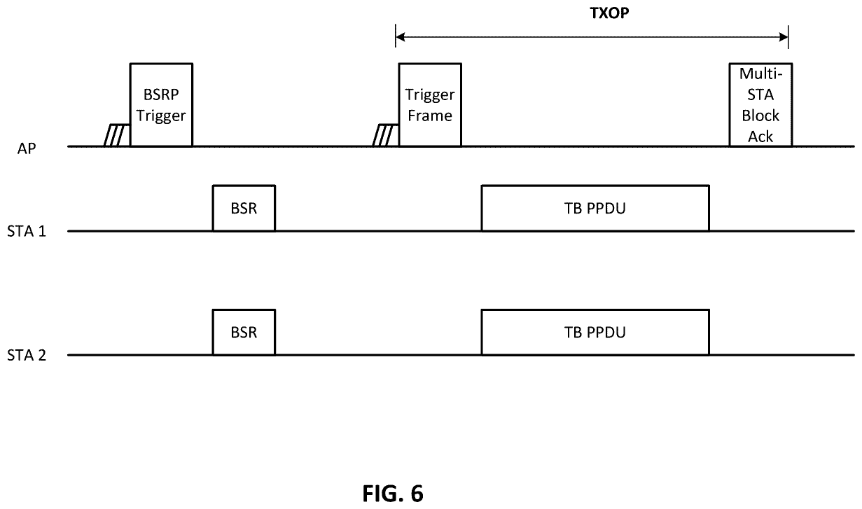

FIG. 6 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a TID for which the STA has a queue size to report to the AP. For example, as shown in FIG. 6, STA 1 may respond to the BSRP trigger frame from the AP by transmitting an A-MPDU including multiple QoS null frames. The QoS null frames each indicates, in its respective QoS control field, a queue size for a respective TID, e.g. TID 0 and TID 2. Similarly, STA 2 may respond to the BSRP trigger frame by transmitting an MPDU including a QoS null frame, which indicates a queue size for TID 2 in its Qos control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield.

On receiving the BSRs from STA 1 and STA 2, the AP may transmit a basic trigger frame to allocate UL MU resources to STA 1 and STA 2. In response, STA 1 may transmit a TB PPDU containing QoS data frames with TID 0 and TID 2 and STA 2 may transmit a TB PPDU containing one or more QoS data frame(s) with TID 2. The AP may acknowledge the transmitted TB PPDUs from STA 1 and STA 2 by sending a multi-STA block ack frame.

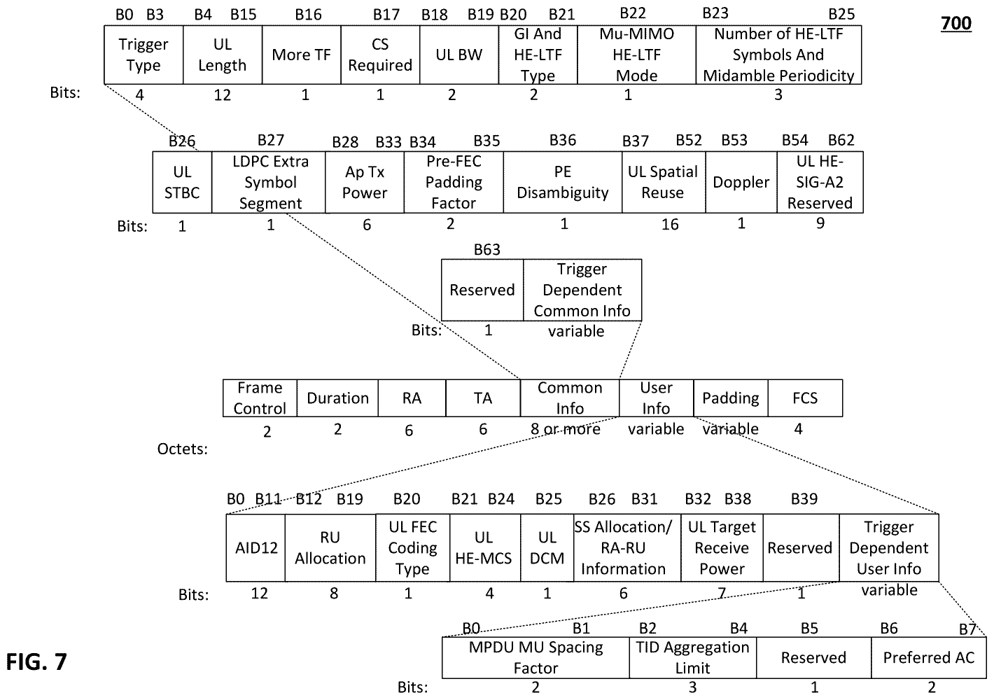

FIG. 7 illustrates an example 700 of a trigger frame format. Trigger frame 700 may correspond to a basic trigger frame as defined in the existing IEEE 802.11ax standard amendment. Trigger frame 700 may be used by an AP to allocate resources for and solicit one or more TB PPDU transmissions from one or more STAs. Trigger frame 700 may also carry other information required by a responding STA to transmit a TB PPDU to the AP.

As shown in FIG. 7, trigger frame 700 includes a Frame Control field, a Duration field, a receiver address (RA) field, a transmitter address (TA) field, a Common Info field, a User Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 700 if trigger frame 700 is addressed to STAs that belong to a single BSS. The TA field is the transmitted BSSID if the trigger frame 700 is addressed to STAs from at least two different BSSs of the multiple BSSID set.

The Common Info field specifies a trigger frame type of trigger frame 700, a transmit power of trigger frame 700 in dBm, and several key parameters of a TB PPDU that is transmitted by a STA in response to trigger frame 700. The trigger frame type of a trigger frame used by an AP to receive QoS data using UL MU operation is referred to as a basic trigger frame.

The User Info field contains a User Info field per STA addressed in trigger frame 700. The per STA User Info field includes, among others, an AID subfield, an RU Allocation subfield, a Spatial Stream (SS) Allocation subfield, an MCS subfield to be used by a STA in a TB PPDU transmitted in response to trigger frame 700, and a Trigger Dependent User Info subfield. The Trigger Dependent User Info subfield i can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 700 to extend the frame length to give recipient STAs enough time to prepare a response for transmission one SIFS after the frame is received. The Padding field, if present, is at least two octets in length and is set to all 1s.

The FCS field is used by a STA to validate a received frame and to interpret certain fields from the MAC headers of a frame.

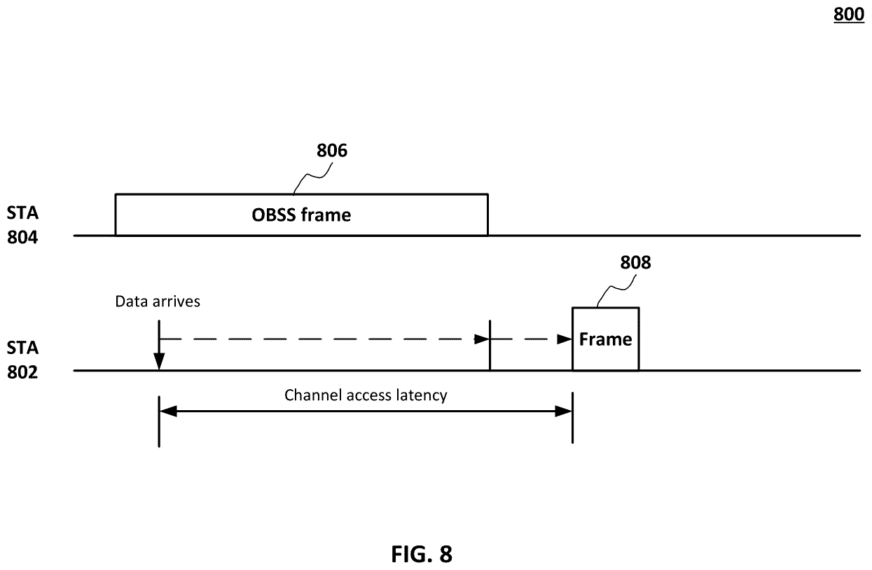

FIG. 8 is an example 800 that illustrates an existing operation mode which may be used by a STA to transmit a frame in the presence of an Overlapping Basic Service Set (OBSS) transmission. As shown in FIG. 8, example 800 includes a STA 802 and a STA 804. As used herein, a STA may refer to an AP STA or a non-AP STA. STA 802 may belong to at first BSS, while STA 804 may belong to a second BSS. The first BSS may be different than the second the BSS. As such, STA 804 may be an OBSS STA relative to STA 802.

In example 800, data may become available for transmission at STA 802 while STA 804 is transmitting a frame 806. In an example, the data becoming available at STA 802 may be latency sensitive data that requires transmission within a short delay (e.g., less than 100 microseconds). In another example, the data becoming available at STA 802 may be of a small size (e.g., less than 20 microseconds long). Frame 806 may be considered an OBSS frame for STA 802.

According to the existing operation mode illustrated in FIG. 8, STA 802 may sense that the channel is busy while the transmission of OBSS frame 806 is ongoing. STA 802 may thus wait until the channel becomes idle before contending for access to the channel (e.g., using EDCA) to transmit a frame 808 containing the data available for transmission. As such, channel access latency for STA 802 may include both waiting for the channel to become idle and a random backoff used for channel access contention. As shown in FIG. 8, the channel access latency for STA 802 to transmit frame 808 may be relatively large and may be unacceptable for the transmission of latency sensitive data.

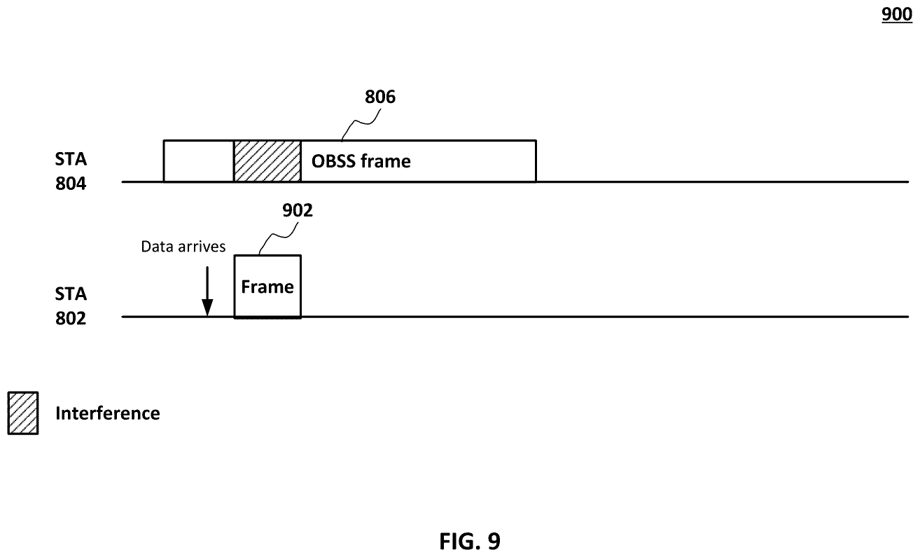

FIG. 9 is an example 900 that illustrates another existing operation mode which may be used by a STA in the presence of an OBSS transmission. For the purpose of illustration, example 900 also includes STAs 802 and 804 as described above in example 800.

As in example 800, in example 900, data may become available for transmission at STA 802 while STA 804 is transmitting a frame 806. In an example, the data becoming available at STA 802 may be latency sensitive data that requires transmission within a short delay (e.g., less than 100 microseconds). In another example, the data becoming available at STA 802 may be of a small size (e.g., less than 20 microseconds long). Frame 806 may be considered an OBSS frame for STA 802.

According to the existing operation mode illustrated in FIG. 9, STA 802 may sense that the channel is busy while the transmission of OBSS frame 806 is ongoing. Nevertheless, when the data available for transmission is latency sensitive (and, in an implementation, additionally shorter than a pre-determined size), STA 802 may not wait for the channel to become idle to transmit frame 808 containing the data available for transmission. Instead, STA 802 may immediately transmit a frame 902 on the channel without contending for channel access.

As shown in FIG. 9, the channel access latency for STA 802 to transmit frame 902 is significantly reduced in example 900 compared to example 800. However, as frame 902 is transmitted concurrently with OBSS frame 806, frame 902 may interfere with the reception by a target STA of a portion of frame 806.

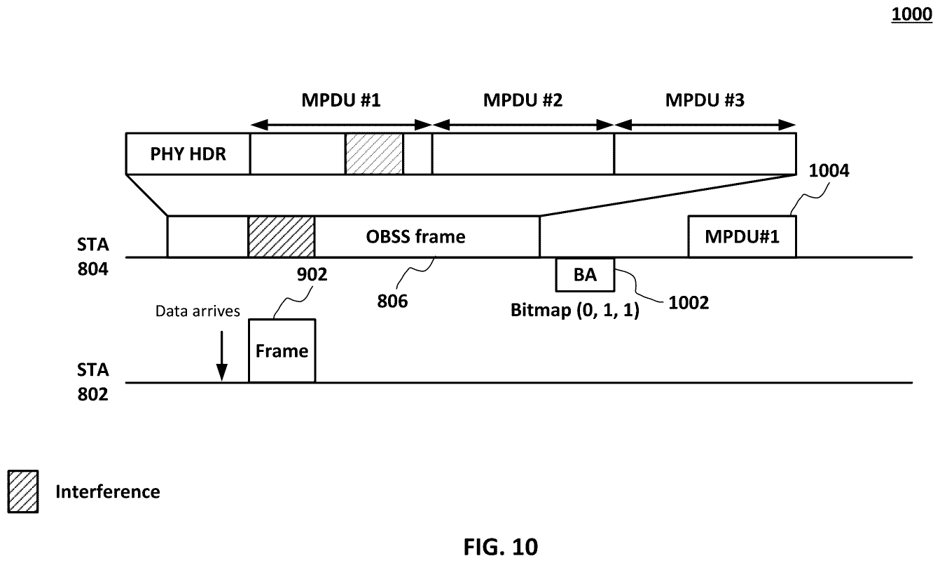

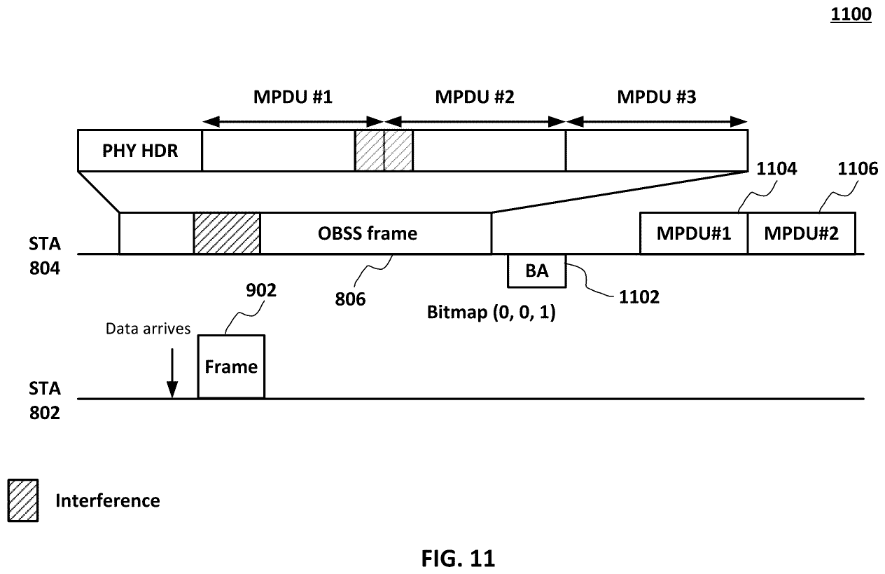

To reduce the interference, frame 902 may be made shorter by using a reduced size PPDU. However, depending on the channel conditions at the target STA of frame 806, frame 902 may still cause sufficient interference that results in the target STA being unable to receive at least a portion of frame 806. FIGS. 10 and 11 are examples 1000 and 1100 that illustrate example interference outcomes that may result from the use of the existing operation mode illustrated in FIG. 9.

In example 1000, STA 802 may transmit frame 902 without waiting for the transmission of OBSS frame 806 to terminate and without contending for channel access. For the purpose of illustration, it is assumed that OBSS frame 806 comprises a PHY header and a plurality of MPDUs (e.g., MPDU #1, MPDU #2, and MPDU #3). It is further assumed for the purpose of illustration that the transmission of frame 902 by STA 802 interferes with a first MPDU (MPDU #1) of OBSS frame 806. Based on the channel conditions at the target STA of OBSS frame 806, the interference due to frame 902 may be sufficiently high that the target STA may not be able to successfully receive MPDU #1 of frame 806. This may be the case despite frame 902 being shorter than a pre-determined size. The target STA may respond to frame 806 by transmitting a Block Ack (BA) frame 1002 comprising a bitmap with the values (0, 1, 1) indicating that MPDU #1 was not successfully received but that MPDUs #2 and #3 were successfully received. In response to BA frame 1002, STA 802 may retransmit MPDU #1 in a subsequent frame 1004.

In example 1100, STA 802 may transmit frame 902 without waiting for the transmission of OBSS frame 806 to terminate and without contending for channel access. For the purpose of illustration, it is again assumed that OBSS frame 806 comprises a PHY header and a plurality of MPDUs (e.g., MPDU #1, MPDU #2, and MPDU #3). It is further assumed for the purpose of illustration that the transmission of frame 902 by STA 802 interferes with both a first MPDU (MPDU #1) and a second MPDU (MPDU #2) of OBSS frame 806. Based on the channel conditions at the target STA of OBSS frame 806, the interference due to frame 902 may be sufficiently high that the target STA may not be able to successfully receive both MPDUs #1 and #2 of frame 806. This may be the case despite frame 902 being shorter than a pre-determined size.

The target STA may respond to frame 806 by transmitting a BA frame 1102 comprising a bitmap with the values (0, 0, 1) indicating that both MPDUs #1 and #2 were not successfully received but that MPDU #3 was successfully received. In response to BA frame 1102, STA 802 may retransmit MPDUs #1 and #2 in one or more subsequent frames, for example frames 1104 and 1106.

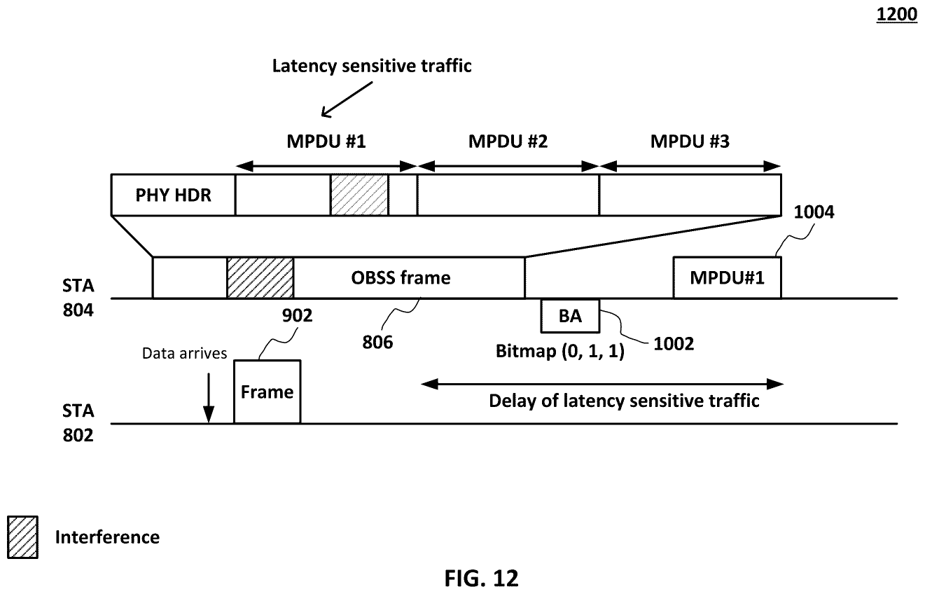

FIG. 12 is an example 1200 that illustrates a problem that may result from the use of the existing operation mode illustrated in FIG. 9. For the purpose of illustration, example 1200 is provided with reference to the example operation described in example 1000 described above. Specifically, in example 1200, frame 902 interferes with MPDU #1 of OBSS frame 806 requiring re-transmission of MPDU #1 in frame 1004. It is further assumed in example 1200 that MPDU #1 of OBSS frame 806 comprises latency sensitive traffic in accordance with a designation of traffic in the OBSS. For example, data of latency sensitive traffic may require transmission within a short delay (e.g., less than 100 microseconds) within the OBSS. As shown in FIG. 12, the interference of frame 902 with OBSS frame 806 may result in a significantly delayed re-transmission of MPDU #1 comprising latency sensitive traffic. This delay may be unacceptable for an application associated with the latency sensitive traffic contained in MPDU #1.

Embodiments of the present disclosure, as further described below, address the above-discussed problems of the existing procedures. In one aspect, embodiments enable a STA wishing to transmit a frame in the presence of an OBSS transmission to avoid transmission overlap with latency sensitive portions of the OBSS transmission. As such, latency sensitive portions of the OBSS transmission may incur no delay due to the concurrent transmission of the frame by the STA. In an embodiment, the OBSS frame may include a latency sensitive (LS) indication that indicates whether the OBSS frame contains LS traffic. In another embodiment, the OBSS frame may further include an indication of a start time of a portion of the OBSS frame that contains LS traffic and/or an indication of a duration of the portion of the OBSS frame that contains LS traffic.

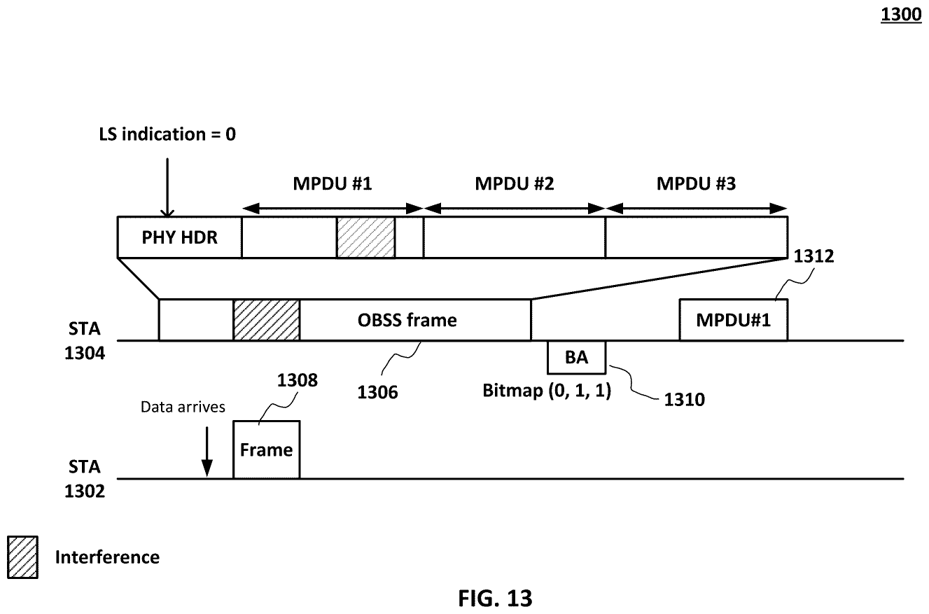

FIG. 13 is an example 1300 that illustrates an example operation mode which may be used by a STA in the presence of an OBSS transmission according to an embodiment. As shown in FIG. 13, example 1300 includes a STA 1302 and a STA 1304. As used herein, a STA may refer to an AP STA or a non-AP STA. In an embodiment, STA 1302 may belong to at first BSS, while STA 1304 may belong to a second BSS. The first BSS may be different than the second the BSS. As such, STA 1304 may be an OBSS STA relative to STA 1302.

As shown in FIG. 13, STA 1304 may access the channel and start to transmit an OBSS frame 1306. In an example, OBSS frame 1306 may include one or more MPDUs (e.g., MPDU #1, MPDU #2, and MPDU #3). In an embodiment, OBSS frame 1306 may include a first indication that indicates whether OBSS frame 1306 contains LS traffic. In an embodiment, STA 1304 may set the first indication to 1 when at least one of the one or more MPDUs contains LS traffic. In an embodiment, STA 1304 may set the first indication to 0 when none of the one or more MPDUs contains LS traffic. In an embodiment, LS traffic comprises traffic associated with a traffic identifier (TID) designated as latency sensitive in the BSS of STA 1304 (OBSS for STA 1302). In another embodiment, the first indication (or another separate indication in frame 1306) may indicate whether pre-emption of OBSS frame 1306 by another STA is allowed. In an embodiment, STA 1304 may set the first indication to 0 when pre-emption of OBSS frame 1306 by another STA is allowed.

In an embodiment, when the first indication is set to 0, the other STA may transmit a frame (e.g., a frame shorter than a pre-defined length) during the transmission of OBSS frame 1306. In an embodiment, STA 1304 may set the first indication to 1 when pre-emption of OBSS frame 1306 by another STA is not allowed. In an embodiment, when the first indication is set to 1, the other STA may not transmit a (short) frame during the transmission of OBSS frame 1306.

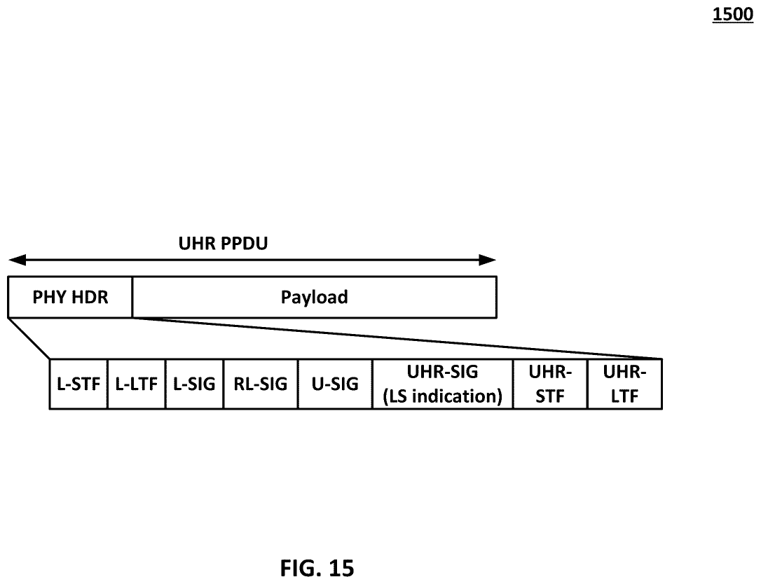

In an embodiment, as shown in FIG. 13, the first indication may be provided in a PHY header of OBSS frame 1306. In an embodiment, OBSS frame 1306 may comprise an Ultra High Reliability (UHR) PHY Protocol Data Unit (PPDU). FIG. 15 illustrates an example UHR PPDU 1500 which may be used for OBSS frame 1306 in an embodiment. As shown, example UHR PPDU 1500 may include a PHY header and a payload. The PHY header may include a legacy Short Training field (L-STF), a legacy Long Training field (L-LTF), a legacy Signal field (L-SIG), a repeated legacy Signal field (RL-SIG), a Universal Signal field (U-SIG), a UHR Signal field (UHR-SIG), a UHR Short Training field (UHR-STF), and a UHR Long Training field (UHR-LTF). In an embodiment, as shown in FIG. 15, the first indication may be provided in the UHR-SIG of the PHY header of UHR PPDU 1500.

Returning to FIG. 13, STA 1302 detects the transmission of OBSS frame 1306. For example, STA 1302 may detect a PHY preamble of OBSS frame 1306. Upon detecting OBSS frame 1306, STA 1302 may decode a portion of OBSS frame 1306 to retrieve the first indication from OBSS frame 1306. In an embodiment, STA 1302 may decode a portion of the PHY header of OBSS frame 1306 to retrieve the first indication. In an embodiment, OBSS frame 1306 may be a UHR PPDU. STA 1302 may decode a UHR-SIG of the PHY header of the UHR PPDU to retrieve the first indication.

In example 1300, data may become available for transmission at STA 1302 while STA 1304 is still transmitting OBSS frame 1306. In an example, the data becoming available at STA 1302 may include latency sensitive data that requires transmission within a short delay (e.g., less than 100 microseconds). In another example, the data becoming available at STA 1302 may be of a small size (e.g., less than 20 microseconds long).

In an embodiment, to transmit the data becoming available for transmission, STA 1302 may access the channel to transmit a frame containing the data based on the first indication obtained from OBSS frame 1306. In an embodiment, if the first indication indicates that OBSS frame 1306 does not contain LS traffic or if the first indication indicates that pre-emption of OBSS frame 1306 by another STA is allowed, STA 1302 accesses the channel to transmit the frame without consideration of overlap of the frame with OBSS frame 1306. In an embodiment, if the first indication indicates that OBSS frame 1306 contains LS traffic or the first indication that indicates pre-emption of OBSS frame 1306 by another STA is not allowed, STA 1302 accesses the channel to transmit the frame with consideration of overlap of the frame with OBSS frame 1306.

In an embodiment, STA 1302 may only access the channel to transmit the frame based on the first indication on condition that the data available for transmission includes latency sensitive data and/or is shorter than a pre-determined size. That is, if the data becoming available for transmission is not latency sensitive and/or shorter than a pre-determined size, STA 1302 may not use the above-described operation based on the first indication. Instead, STA 1302 may utilize an existing procedure as described above in FIG. 8 for example, which may include waiting for an end of the transmission of OBSS frame 1306 before contending to access the channel.

In an embodiment, accessing the channel without consideration of overlap of the frame with the transmission of OBSS frame 1306 may include STA 1302 immediately transmitting the frame on the channel without contending for channel access. In another embodiment, STA 1302 may still contend for the channel (ignoring OBSS frame 1306) before transmitting the frame.

In an embodiment, accessing the channel to transmit the frame with consideration of overlap of the frame with OBSS frame 1306 comprises accessing the channel to transmit the frame after an end of transmission of OBSS frame 1306. In an embodiment, accessing the channel to transmit the frame with consideration of overlap of the frame with OBSS frame 1306 comprises accessing the channel to transmit the frame at a time that avoids overlap with a portion of OBSS frame 1306 containing LS traffic.

In example 1300, the first indication in OBSS frame 1306 is set to 0 indicating absence of LS traffic in OBSS frame 1306 or allowance of preemption of OBSS frame 1306 by another STA. Based on the first indication being set to 0, STA 1302 transmits a frame 1308 containing the data becoming available for transmission without consideration of overlap with OBSS frame 1306. As shown, STA 1302 may transmit frame 1308 immediately after the data becomes available. In an embodiment, STA 1302 may not contend for channel access before transmitting frame 1308. In another embodiment, STA 1302 may still contend for the channel (ignoring OBSS frame 1306) before transmitting frame 1308.

In example 1300, frame 1308 may overlap with a portion of MPDU #1 of OBSS frame 1306. This overlap may cause reception failure of MPDU #1 at a target STA of OBSS frame 1306. The target STA may respond to frame 1306 by transmitting a BA frame 1310 comprising a bitmap with the values (0, 1, 1) indicating that MPDU #1 was not successfully received but that MPDUs #2 and #3 were successfully received. In response to BA frame 1310, STA 1302 may retransmit MPDU #1 in a subsequent frame 1312 to the target STA.

As shown, the reception of MPDU #1 by the target STA may be delayed in example 1300. However, as MPDU #1 does not contain latency sensitive data (as indicated by the first indication being set to 0), the delay of MPDU #1 may be tolerated by the target STA. In return, however, the transmission delay of frame 1308 is significantly reduced, which is particularly beneficial when frame 1308 contains latency sensitive data.

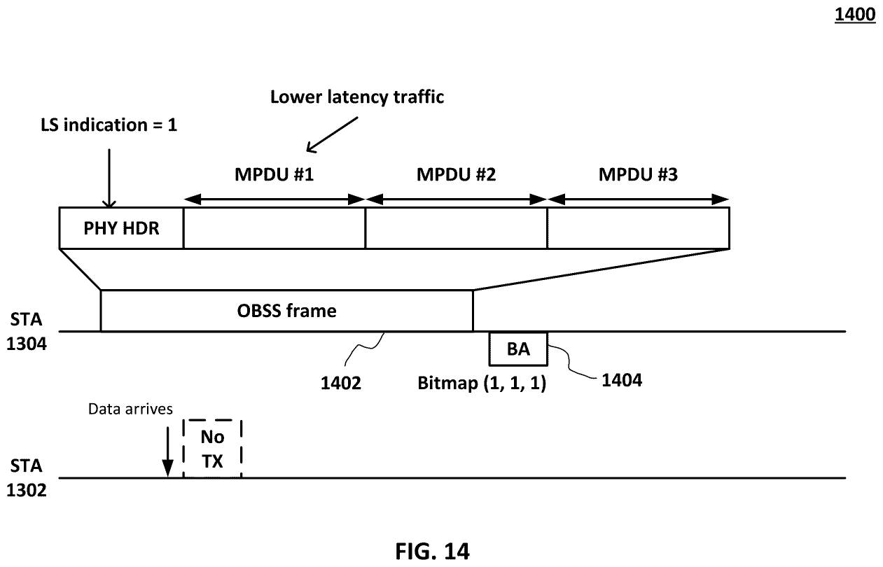

FIG. 14 is another example 1400 that illustrates another example operation mode which may be used by a STA in the presence of an OBSS transmission according to an embodiment. Like example 1300, example 1400 also includes STA 1302 and STA 1304 described above.

As shown in FIG. 14, STA 1304 may access the channel and start to transmit an OBSS frame 1402. In an example, OBSS frame 1402 may include one or more MPDUs (e.g., MPDU #1, MPDU #2, and MPDU #3). In an embodiment, OBSS frame 1402 may include a first indication that indicates whether OBSS frame 1402 contains LS traffic. In an embodiment, STA 1304 may set the first indication to 1 when at least one of the one or more MPDUs contains LS traffic. In an embodiment, STA 1304 may set the first indication to 0 when none of the one or more MPDUs contains LS traffic. In another embodiment, the first indication (or another separate indication in frame 1402) may indicate whether pre-emption of OBSS frame 1402 by another STA is allowed. In an embodiment, STA 1304 may set the first indication to 0 when pre-emption of OBSS frame 1402 by another STA is allowed. In an embodiment, when the first indication is set to 0, the other STA may transmit a frame (e.g., a frame shorter than a pre-defined length) during the transmission of OBSS frame 1402. In an embodiment, STA 1304 may set the first indication to 1 when pre-emption of OBSS frame 1402 by another STA is not allowed. In an embodiment, when the first indication is set to 1, the other STA may not transmit a (short) frame during the transmission of OBSS frame 1402. In an embodiment, as shown in FIG. 14, the first indication may be provided in a PHY header of OBSS frame 1402. In an embodiment, OBSS frame 1402 may comprise a UHR PPDU as illustrated in FIG. 15. In an embodiment, as shown in FIG. 15, the first indication may be provided in the UHR-SIG of the PHY header of the UHR PPDU.

STA 1302 detects the transmission of OBSS frame 1402. For example, STA 1302 may detect a PHY preamble of OBSS frame 1402. Upon detecting OBSS frame 1402, STA 1302 may decode a portion of OBSS frame 1402 to retrieve the first indication from OBSS frame 1402. In an embodiment, STA 1302 may decode a portion of the PHY header of OBSS frame 1402 to retrieve the first indication. In an embodiment, OBSS frame 1402 may be a UHR PPDU. STA 1302 may decode a UHR-SIG of the PHY header of the UHR PPDU to retrieve the first indication.

In example 1400, data may become available for transmission at STA 1302 while STA 1304 is still transmitting OBSS frame 1402. In an example, the data becoming available at STA 1302 may include latency sensitive data that requires transmission within a short delay (e.g., less than 100 microseconds). In another example, the data becoming available at STA 1302 may be of a small size (e.g., less than 20 microseconds long).

In an embodiment, to transmit the data becoming available for transmission, STA 1302 may access the channel to transmit a frame containing the data based on the first indication obtained from OBSS frame 1402. In an embodiment, if the first indication indicates that OBSS frame 1402 does not contain LS traffic or if the first indication indicates that pre-emption of OBSS frame 1402 by another STA is allowed, STA 1302 accesses the channel to transmit the frame without consideration of overlap of the frame with OBSS frame 1402. In an embodiment, if the first indication indicates that OBSS frame 1402 contains LS traffic or if the first indication indicates that pre-emption of OBSS frame 1402 by another STA is allowed, STA 1302 accesses the channel to transmit the frame with consideration of overlap of the frame with OBSS frame 1402.

In example 1400, the first indication in OBSS frame 1402 is set to 1 indicating presence of LS traffic in OBSS frame 1402 or disallowance of preemption of OBSS frame 1402 by the another STA. Based on the first indication being set to 1, STA 1302 may access the channel to transmit the frame containing the data becoming available with consideration of overlap of the frame with OBSS frame 1402. In an embodiment, as shown in FIG. 14, STA 1302 may avoid overlap with OBSS frame 1402 and may omit transmitting the frame while the transmission of OBSS frame 1402 is ongoing. In an embodiment, STA 1302 may wait until an end of transmission of OBSS frame 1402 (e.g., until the channel become idle) before contending for channel access to transmit the frame.

Based on this operation mode, STA 1302 does not interfere with the reception of OBSS frame 1402 by a target STA. The target STA may respond to frame 1402 by transmitting a BA frame 1404 comprising a bitmap with the values (1, 1, 1) indicating that all of MPDU #1, MPDU #2, and MPDU #3 were successfully received. As such, no retransmission of any portion of OBSS frame 1402 is required and low latency for LS traffic of OBSS frame 1402 is achieved.

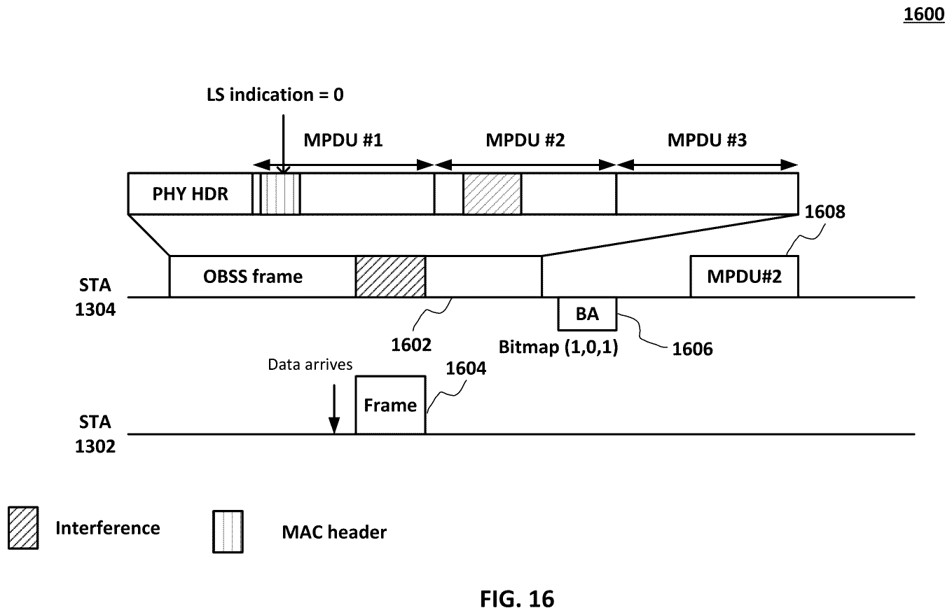

FIG. 16 is an example 1600 that illustrates another example operation mode which may be used by a STA in the presence of an OBSS transmission according to an embodiment. Like example 1300, example 1600 also includes STA 1302 and STA 1304 described above.

As shown in FIG. 16, STA 1304 may access the channel and start to transmit an OBSS frame 1602. In an example, OBSS frame 1602 may include one or more MPDUs (e.g., MPDU #1, MPDU #2, and MPDU #3). In an embodiment, OBSS frame 1602 may include a first indication that indicates whether OBSS frame 1602 contains LS traffic. In an embodiment, STA 1304 may set the first indication to 1 when at least one of the one or more MPDUs contains LS traffic. In an embodiment, STA 1304 may set the first indication to 0 when none of the one or more MPDUs contains LS traffic. In another embodiment, the first indication (or another separate indication in frame 1602) may indicate whether pre-emption of OBSS frame 1602 by another STA is allowed. In an embodiment, STA 1304 may set the first indication to 0 when pre-emption of OBSS frame 1602 by another STA is allowed. In an embodiment, when the first indication is set to 0, the other STA may transmit a frame (e.g., a frame shorter than a pre-defined length) during the transmission of OBSS frame 1602. In an embodiment, STA 1304 may set the first indication to 1 when pre-emption of OBSS frame 1602 by another STA is not allowed. In an embodiment, when the first indication is set to 1, the other STA may not transmit a (short) frame during the transmission of OBSS frame 1602.

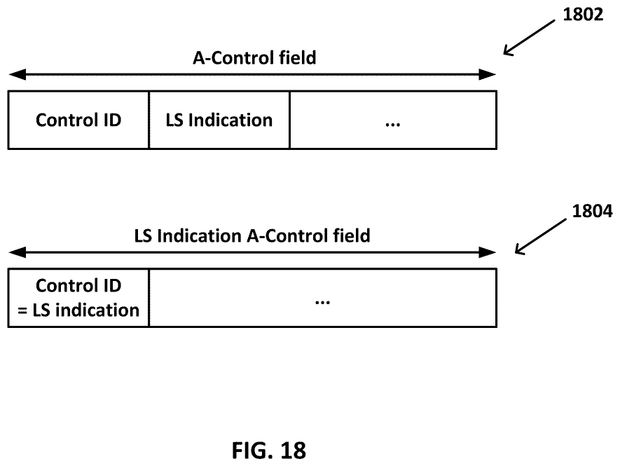

In an embodiment, as shown in FIG. 16, the first indication may be provided in a MAC header of OBSS frame 1602. In an embodiment, the first indication may be provided in the MAC header of a first occurring MPDU (e.g., MPDU #1) of OBSS frame 1602. However, embodiments are not limited as such and the first indication may be provided in the MAC header of any MPDU of OBSS frame 1602. In an embodiment, OBSS frame 1602 may comprise a UHR PPDU. In an embodiment, the first indication may be provided in an Aggregated Control (A-Control) field or an LS indication A-Control field of a MAC header of the UHR PPDU. The A-Control field or the LS indication A-Control field may be provided in a control field (e.g., QoS Control field or UHR Control field) of the MAC header of the UHR PPDU. In an example, the A-Control field may have the format of example A-Control field 1802 shown in FIG. 18. As shown, the A-Control field may include an LS indication subfield in which the first indication may be provided. In an example, the LS indication A-Control may have the format of example LS indication A-Control field 1804 shown in FIG. 18. As shown, LS indication A-Control field includes a Control ID subfield which may be used to provide the first indication.

Returning to FIG. 16, STA 1302 detects the transmission of OBSS frame 1602. For example, STA 1302 may detect a PHY preamble of OBSS frame 1602. Upon detecting OBSS frame 1602, STA 1302 may decode a portion of OBSS frame 1602 to retrieve the first indication from OBSS frame 1602. In an embodiment, STA 1302 may decode a portion of a MAC header of OBSS frame 1602 to retrieve the first indication. In an embodiment, STA 1302 may decode the MAC header of an MPDU (e.g., MPDU #1) of OBSS frame 1602. In an embodiment, OBSS frame 1602 may be a UHR PPDU. STA 1302 may decode an A-Control field or an LS indication A-Control field of the MAC header of the UHR PPDU to retrieve the first indication.

In example 1600, data may become available for transmission at STA 1302 while STA 1304 is still transmitting OBSS frame 1602. In an example, the data becoming available at STA 1302 may include latency sensitive data that requires transmission within a short delay (e.g., less than 100 microseconds). In another example, the data becoming available at STA 1302 may be of a small size (e.g., less than 20 microseconds long).

In an embodiment, to transmit the data becoming available for transmission, STA 1302 may access the channel to transmit a frame containing the data based on the first indication obtained from OBSS frame 1602. In an embodiment, if the first indication indicates that OBSS frame 1602 does not contain LS traffic, STA 1302 accesses the channel to transmit the frame without consideration of overlap of the frame with OBSS frame 1602. In an embodiment, if the first indication indicates that OBSS frame 1602 contains LS traffic, STA 1302 accesses the channel to transmit the frame with consideration of overlap of the frame with OBSS frame 1602.

In example 1600, the first indication in OBSS frame 1602 is set to 0 indicating absence of LS traffic in OBSS frame 1602. Based on the first indication being set to 0, STA 1302 transmits a frame 1604 containing the data becoming available for transmission without consideration of overlap with OBSS frame 1602. As shown, STA 1302 may transmit frame 1604 immediately after the data becomes available. In an embodiment, STA 1302 may not contend for channel access before transmitting frame 1604. In another embodiment, STA 1302 may still contend for the channel (ignoring OBSS frame 1602) before transmitting frame 1604.

In an embodiment, depending on the location of the first indication in OBSS frame 1602, STA 1302 may have to wait until one or more MPDUs of OBSS frame 1602 have been transmitted before starting to transmit frame 1604. For example, as shown in FIG. 16, if the first indication is provided in the MAC header of MPDU #1, STA 1302 may have to wait until MPDU #1 has been successfully received in order to be able to decode the first indication from the MAC header of MPDU #1. STA 1302 may then transmit frame 1604 after the transmission of MPDU #1 has ended in accordance with the first indication. In an, STA 1304 may use MPDU #1 for latency sensitive data, if any, based on the knowledge that STA 1302 may not begin transmission of frame 1604 until MPDU #1 has been fully transmitted.

In an embodiment, as the earliest possible location of the first indication within OBSS frame 1602 is the MAC header of MPDU #1, STA 1302 may not transmit frame 1604 before the transmission of MPDU #1 has ended.

In an embodiment, STA 1304 may provide the first indication in the MAC header of MPDU #1 to allow STA 1302 to learn whether OBSS frame 1602 contains LS traffic as early as possible. In an embodiment, STA 1304 may not use MPDUs occurring before the MPDU which MAC header is used to provide the first indication for latency sensitive data. In an embodiment, STA 1304 may further not use the MPDU which MAC header is used to provide the first indication for latency sensitive data.

In example 1600, the first indication is provided in the MAC header of MPDU #1. As such, and based on the first indication being set to 0, STA 1302 transmits frame 1604 after the transmission of MPDU #1 has ended. Frame 1604 may overlap with a portion of MPDU #2 of OBSS frame 1602. This overlap may cause reception failure of MPDU #2 at a target STA of OBSS frame 1602. The target STA may respond to frame 1602 by transmitting a BA frame 1606 comprising a bitmap with the values (1, 0, 1) indicating that MPDU #2 was not successfully received but that MPDUs #1 and #3 were successfully received. In response to BA frame 1606, STA 1302 may retransmit MPDU #1 in a subsequent frame 1608 to the target STA.

As shown, the reception of MPDU #2 by the target STA may be delayed in example 1600. However, as MPDU #2 does not contain latency sensitive data (as indicated by the first indication being set to 0), the delay of MPDU #2 may be tolerated by the target STA. In return, however, the transmission delay of frame 1604 is significantly reduced, which is particularly beneficial when frame 1604 contains latency sensitive data.

For example, if the first indication is provided in the MAC header of any MPDU of frame 1602, STA 1302 may have to wait until an MPDU comprising the first indication has been successfully received in order to be able to decode the first indication from the MAC header of the MPDU. STA 1302 may then transmit frame 1604 after the transmission of the MPDU has ended in accordance with the first indication. In an embodiment, STA 1304 may use the MPDU for latency sensitive data, if any, based on the knowledge that STA 1302 may not begin transmission of frame 1604 until the MPDU has been fully received.

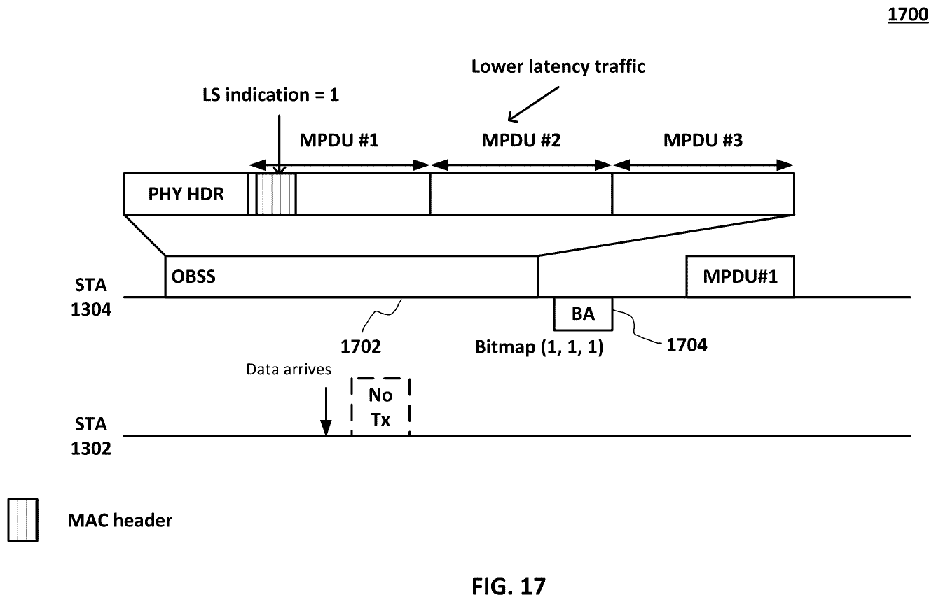

FIG. 17 is an example 1700 that illustrates another example operation mode which may be used by a STA in the presence of an OBSS transmission according to an embodiment. Like example 1300, example 1700 also includes STA 1302 and STA 1304 described above.

As shown in FIG. 17, STA 1304 may access the channel and start to transmit an OBSS frame 1702. In an example, OBSS frame 1702 may include one or more MPDUs (e.g., MPDU #1, MPDU #2, and MPDU #3). In an embodiment, OBSS frame 1702 may include a first indication that indicates whether OBSS frame 1702 contains LS traffic. In an embodiment, STA 1304 may set the first indication to 1 when at least one of the one or more MPDUs contains LS traffic. In an embodiment, STA 1304 may set the first indication to 0 when none of the one or more MPDUs contains LS traffic.

In an embodiment, as shown in FIG. 17, the first indication may be provided in a MAC header of OBSS frame 1702. In an embodiment, the first indication may be provided in the MAC header of a first occurring MPDU (e.g., MPDU #1) of OBSS frame 1702. However, embodiments are not limited as such and the first indication may be provided in the MAC header of any MPDU of OBSS frame 1702. In an embodiment, OBSS frame 1702 may comprise a UHR PPDU. In an embodiment, the first indication may be provided in an Aggregated Control (A-Control) field or an LS indication A-Control field of a MAC header of the UHR PPDU. The A-Control field or the LS indication A-Control field may be provided in a control field (e.g., QoS Control field or UHR Control field) of the MAC header of the UHR PPDU. In an example, the A-Control field may have the format of example A-Control field 1802 shown in FIG. 18. As shown, the A-Control field may include an LS indication subfield in which the first indication may be provided. In an example, the LS indication A-Control may have the format of example LS indication A-Control field 1804 shown in FIG. 18. As shown, LS indication A-Control field includes a Control ID subfield which may be used to provide the first indication.

Returning to FIG. 17, STA 1302 detects the transmission of OBSS frame 1702. For example, STA 1302 may detect a PHY preamble of OBSS frame 1702. Upon detecting OBSS frame 1702, STA 1302 may decode a portion of OBSS frame 1702 to retrieve the first indication from OBSS frame 1702. In an embodiment, STA 1302 may decode a portion of a MAC header of OBSS frame 1702 to retrieve the first indication. In an embodiment, STA 1302 may decode the MAC header of an MPDU (e.g., MPDU #1) of OBSS frame 1702. In an embodiment, OBSS frame 1702 may be a UHR PPDU. STA 1302 may decode an A-Control field or an LS indication A-Control field of the MAC header of the UHR PPDU to retrieve the first indication.

In example 1700, data may become available for transmission at STA 1302 while STA 1304 is still transmitting OBSS frame 1702. In an example, the data becoming available at STA 1302 may include latency sensitive data that requires transmission within a short delay (e.g., less than 100 microseconds). In another example, the data becoming available at STA 1302 may be of a small size (e.g., less than 20 microseconds long).

In an embodiment, to transmit the data becoming available for transmission, STA 1302 may access the channel to transmit a frame containing the data based on the first indication obtained from OBSS frame 1702. In an embodiment, if the first indication indicates that OBSS frame 1702 does not contain LS traffic or if the first indication indicates that pre-emption of OBSS frame 1702 by another STA is allowed, STA 1302 accesses the channel to transmit the frame without consideration of overlap of the frame with OBSS frame 1702. In an embodiment, if the first indication indicates that OBSS frame 1702 contains LS traffic or if the first indication indicates that pre-emption of OBSS frame 1402 by another STA is not allowed, STA 1302 accesses the channel to transmit the frame with consideration of overlap of the frame with OBSS frame 1702.

In example 1700, the first indication in OBSS frame 1702 is set to 1 indicating presence of LS traffic in OBSS frame 1702. Based on the first indication being set to 1, STA 1302 may access the channel to transmit the frame containing the data becoming available with consideration of overlap of the frame with OBSS frame 1702. In an embodiment, as shown in FIG. 17, STA 1302 may avoid overlap with OBSS frame 1702 and may omit transmitting the frame while the transmission of OBSS frame 1702 is ongoing. In an embodiment, STA 1302 may wait until an end of transmission of OBSS frame 1702 (e.g., until the channel become idle) before contending for channel access to transmit the frame.

Based on this operation mode, STA 1302 does not interfere with the reception of OBSS frame 1702 by a target STA. The target STA may respond to frame 1702 by transmitting a BA frame 1704 comprising a bitmap with the values (1, 1, 1) indicating that all of MPDU #1, MPDU #2, and MPDU #3 were successfully received. As such, no retransmission of any portion of OBSS frame 1702 is required and low latency for LS traffic of OBSS frame 1702 is achieved.

In an embodiment, depending on the location of the first indication in OBSS frame 1702, STA 1302 may have to wait until one or more MPDUs of OBSS frame 1702 have been transmitted before determining whether to transmit the frame containing the data becoming available for transmission. In example 1700, STA 1304 includes the first indication in the MAC header of MPDU #1. Upon receiving MPDU #1, STA 1302 may decode the portion of the MAC header including the first indication. STA 1302 may then operate in accordance with the above-described operation mode.

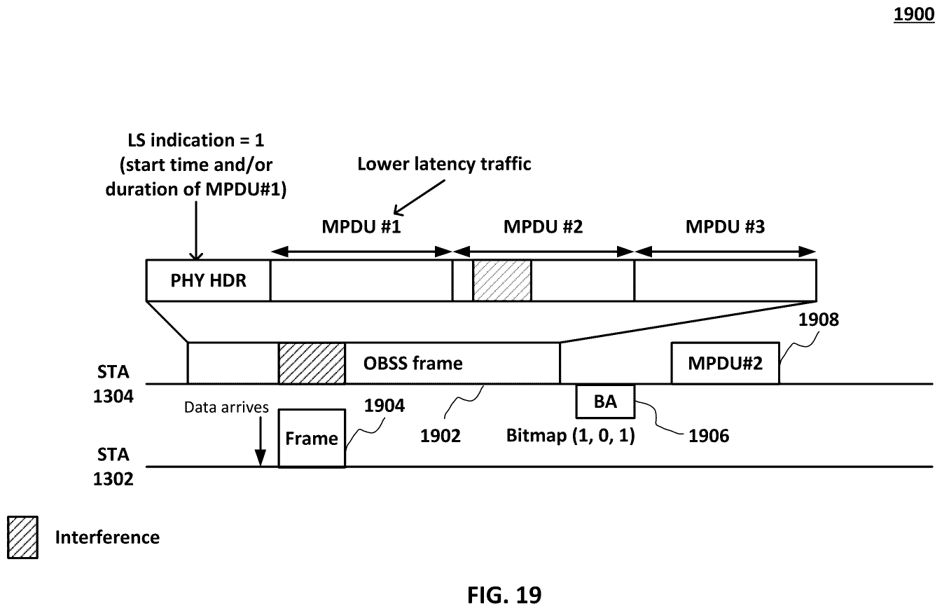

FIG. 19 is an example 1900 that illustrates another example operation mode which may be used by a STA in the presence of an OBSS transmission according to an embodiment. As in example 1300, example 1900 also includes STA 1302 and STA 1304 described above.

As shown in FIG. 19, STA 1304 may access the channel and start to transmit an OBSS frame 1902. In an example, OBSS frame 1902 may include one or more MPDUs (e.g., MPDU #1, MPDU #2, and MPDU #3). In an embodiment, OBSS frame 1902 may include a first indication that indicates whether OBSS frame 1902 contains LS traffic. In an embodiment, STA 1304 may set the first indication to 1 when at least one of the one or more MPDUs contains LS traffic. In an embodiment, STA 1304 may set the first indication to 0 when none of the one or more MPDUs contains LS traffic. In an embodiment, LS traffic comprises traffic associated with a traffic identifier (TID) designated as latency sensitive in the BSS of STA 1304 (OBSS for STA 1302). In another embodiment, the first indication (or another separate indication in frame 1602) may indicate whether pre-emption of OBSS frame 1902 by another STA is allowed. In an embodiment, STA 1304 may set the first indication to 0 when pre-emption of OBSS frame 1902 by another STA is allowed. In an embodiment, when the first indication is set to 0, the other STA may transmit a frame (e.g., a frame shorter than a pre-defined length) during the transmission of OBSS frame 1902. In an embodiment, STA 1304 may set the first indication to 1 when pre-emption of OBSS frame 1902 by another STA is not allowed. In an embodiment, when the first indication is set to 1, the other STA may not transmit a (short) frame during the transmission of OBSS frame 1902.

In an embodiment, as illustrated in FIG. 19, when the first indication is set to 1, OBSS frame 1902 may further include a second indication of a start time of a portion of the OBSS frame 1902 containing the LS traffic; and/or a third indication of a duration of the portion of OBSS frame 1902 containing the LS traffic. In an embodiment, if the LS traffic is contained in a single MPDU within OBSS frame 1902, the start time refers to the start time of the single MPDU containing LS traffic and the duration refers to the duration of the same MPDU. In an embodiment, if the LS traffic is contained in multiple consecutive MPDUs of OBSS frame 1902, the start time refers to the start time of the first occurring MPDU containing LS traffic and the duration refers to the total duration of the multiple consecutive MPDUs. In an embodiment, if the LS traffic is contained in multiple non-consecutive MPDUs of OBSS frame 1902, the start time refers to the start time of the first occurring MPDU containing LS traffic and the duration refers to the duration from the first occurring MPDU containing LS traffic to the last occurring MPDU containing LS traffic of the multiple non-consecutive MPDUs. In another embodiment, multiple second indications and/or multiple third indications may be provided in OBSS frame 1902 in the case of multiple non-consecutive MPDUs containing LS traffic in OBSS frame 1902.

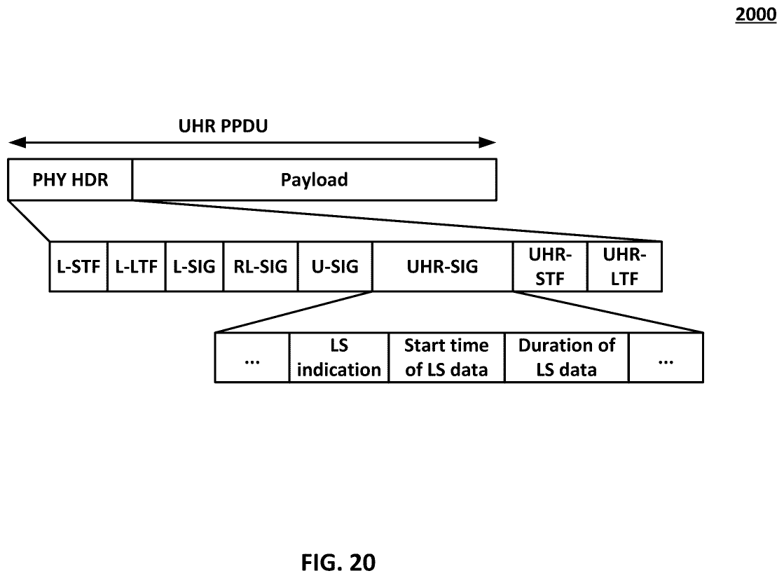

In an embodiment, as shown in FIG. 19, the first indication, the second indication(s), and the third indication(s) may be provided in a PHY header of OBSS frame 1902. In an embodiment, OBSS frame 1902 may comprise a UHR PPDU. FIG. 20 illustrates an example UHR PPDU 2000 which may be used for OBSS frame 1902 in an embodiment. As shown, example UHR PPDU 2000 may include a PHY header and a payload. The PHY header may include a legacy Short Training field (L-STF), a legacy Long Training field (L-LTF), a legacy Signal field (L-SIG), a repeated legacy Signal field (RL-SIG), a Universal Signal field (U-SIG), a UHR Signal field (UHR-SIG), a UHR Short Training field (UHR-STF), and a UHR Long Training field (UHR-LTF). In an embodiment, as shown in FIG. 20, the first indication, the second indication, and the third indication may be provided in respective subfields in the UHR-SIG of the PHY header of UHR PPDU 2000. In an embodiment, when the first indication is set to 0, the second indication and the third indication may also be set to a pre-determined value (e.g., 0). An advantage of having the first indication, the second indication, and the third indication in the PHY header of frame 1902 is that STA 1302 may quickly determine the location of LS traffic, if any, within OBSS frame 1904. Specifically, STA 1302 does not need to decode an MPDU of frame 1902 to determine the location of LS traffic, if any, in OBSS frame 1904.

Returning to FIG. 19, STA 1302 detects the transmission of OBSS frame 1902. For example, STA 1302 may detect a PHY preamble of OBSS frame 1902. Upon detecting OBSS frame 1902, STA 1302 may decode a portion of OBSS frame 1902 to retrieve the first indication from OBSS frame 1902. In an embodiment, STA 1302 may decode a portion of the PHY header of OBSS frame 1902 to retrieve the first indication. In an embodiment, OBSS frame 1902 may be a UHR PPDU. STA 1302 may decode a UHR-SIG of the PHY header of the UHR PPDU to retrieve the first indication. In an embodiment, where the first indication is set to 1 in OBSS frame 1902, STA 1302 further decodes a portion of the PHY header of OBSS frame 1902 to retrieve the second indication and/or the third indication. In an embodiment, OBSS frame 1902 may be a UHR PPDU. STA 1302 may decode a UHR-SIG of the PHY header of the UHR PPDU to retrieve the second indication and/or the third indication.

In example 1900, data may become available for transmission at STA 1302 while STA 1304 is still transmitting OBSS frame 1902. In an example, the data becoming available at STA 1302 may include latency sensitive data that requires transmission within a short delay (e.g., less than 100 microseconds). In another example, the data becoming available at STA 1302 may be of a small size (e.g., less than 20 microseconds long).

In an embodiment, to transmit the data becoming available for transmission, STA 1302 may access the channel to transmit a frame containing the data based on the first indication obtained from OBSS frame 1902. In an embodiment, if the first indication indicates that OBSS frame 1902 does not contain LS traffic or if the first indication indicates that pre-emption of OBSS frame 1902 by another STA is allowed, STA 1302 accesses the channel to transmit the frame without consideration of overlap of the frame with OBSS frame 1902. In an embodiment, if the first indication indicates that OBSS frame 1902 contains LS traffic or if the first indication indicates that pre-emption of OBSS frame 1702 by another STA is not allowed, STA 1302 accesses the channel to transmit the frame with consideration of overlap of the frame with OBSS frame 1902.

In an embodiment, STA 1302 may only access the channel to transmit the frame based on the first indication on condition that the data available for transmission includes latency sensitive data and/or is shorter than a pre-determined size. That is, if the data becoming available for transmission is not latency sensitive and/or shorter than a pre-determined size, STA 1302 may not use the above-described operation based on the first indication. Instead, STA 1302 may utilize an existing procedure as described above in FIG. 8 for example, which may include waiting for an end of the transmission of OBSS frame 1902 before contending to access the channel.

In an embodiment, accessing the channel without consideration of overlap of the frame with the transmission of OBSS frame 1902 may include STA 1302 immediately transmitting the frame on the channel without contending for channel access. In another embodiment, STA 1302 may still contend for the channel (ignoring OBSS frame 1902) before transmitting the frame.

In an embodiment, accessing the channel to transmit the frame with consideration of overlap of the frame with OBSS frame 1902 comprises accessing the channel to transmit the frame after an end of transmission of OBSS frame 1902. In an embodiment, accessing the channel to transmit the frame with consideration of overlap of the frame with OBSS frame 1902 comprises accessing the channel to transmit the frame at a time that avoids overlap with a portion of OBSS frame 1902 containing LS traffic.

In an embodiment, accessing the channel to transmit the frame at a time that avoids overlap with the portion of OBSS frame 1902 containing LS traffic comprises determining a time to transmit the frame based on the start time and/or the duration of the portion of the OBSS frame containing LS traffic. In an embodiment, accessing the channel to transmit the frame at a time that avoids overlap with the portion of OBSS frame 1902 containing LS traffic comprises accessing the channel to transmit the frame before or after transmission of the portion of the OBSS frame 1902 containing LS traffic. In an embodiment, the frame containing the data becoming available for transmission may not be transmitted without overlapping with the portion of OBSS frame 1902 containing LS traffic. In such an embodiment, STA 1302 may transmit the frame only when the data becoming available for transmission includes latency sensitive data and/or is shorter than a pre-determined size.

In example 1900, the first indication in OBSS frame 1902 is set to 1 indicating presence of LS traffic in OBSS frame 1902 or disallowance of preemption of OBSS frame 1902 by another STA. Further, OBSS frame 1902 may include the second indication and/or the third indication indicating respectively the start time and/or duration of the portion of OBSS frame 1902 containing LS traffic. In example 1900, it is assumed that this portion corresponds to MPDU #1 only. Based on the first indication being set to 1, STA 1302 retrieves the second indication and/or the third indication from OBSS frame 1902. Using the second indication and/or the third indication, STA 1302 determines that the LS traffic may be transmitted without overlapping MPDU #1. Accordingly, STA 1302 begins to transmit a frame 1904 containing the data becoming available for transmission after transmission of MPDU #1 has ended. In an embodiment, STA 1302 may transmit frame 1904 immediately after the transmission of MPDU #1 has ended. In an embodiment, STA 1302 may not contend for channel access before transmitting frame 1904. In another embodiment, STA 1302 may still contend for the channel (ignoring OBSS frame 1902) before transmitting frame 1904.

In example 1900, frame 1904 may overlap with a portion of MPDU #2 of OBSS frame 1902. This overlap may cause reception failure of MPDU #2 at a target STA of OBSS frame 1902. The target STA may respond to frame 1902 by transmitting a BA frame 1906 comprising a bitmap with the values (1, 0, 1) indicating that MPDU #2 was not successfully received but that MPDUs #1 and #3 were successfully received. In response to BA frame 1906, STA 1302 may retransmit MPDU #2 in a subsequent frame 1908 to the target STA.

As shown, the reception of MPDU #2 by the target STA may be delayed in example 1900. However, as MPDU #2 does not contain latency sensitive data (based on the second indication and/or the third indication), the delay of MPDU #2 may be tolerated by the target STA. In return, however, the transmission delay of frame 1904 is significantly reduced, which is particularly beneficial when frame 1904 contains latency sensitive data.

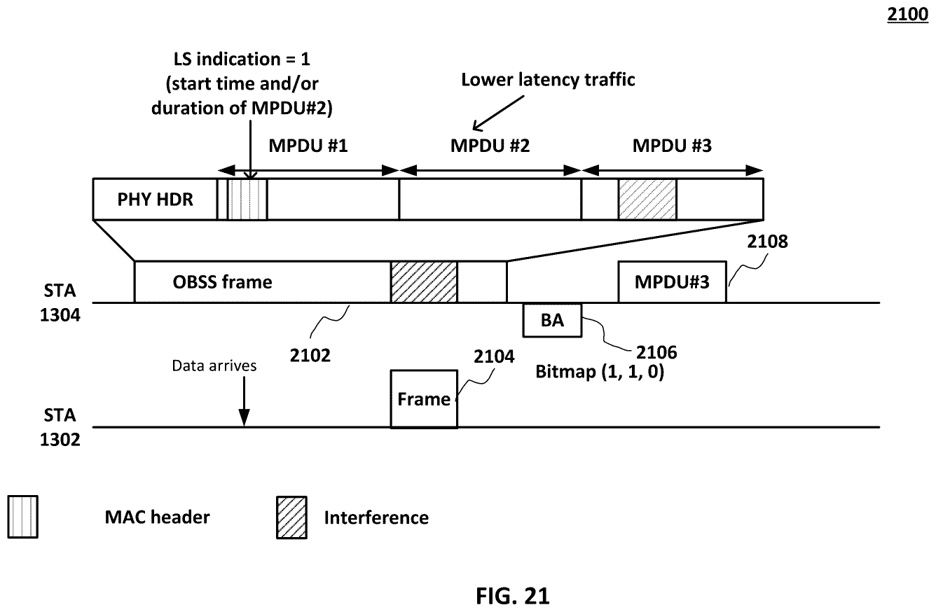

FIG. 21 is an example 2100 that illustrates another example operation which may be used by a STA in the presence of an OBSS transmission according to an embodiment. As in example 1300, example 2100 also includes STA 1302 and STA 1304 described above.

As shown in FIG. 21, STA 1304 may access the channel and start to transmit an OBSS frame 2102. In an example, OBSS frame 2102 may include one or more MPDUs (e.g., MPDU #1, MPDU #2, and MPDU #3). In an embodiment, OBSS frame 2102 may include a first indication that indicates whether OBSS frame 2102 contains LS traffic. In an embodiment, STA 1304 may set the first indication to 1 when at least one of the one or more MPDUs contains LS traffic. In an embodiment, STA 1304 may set the first indication to 0 when none of the one or more MPDUs contains LS traffic. In an embodiment, LS traffic comprises traffic associated with a traffic identifier (TID) designated as latency sensitive in the BSS of STA 1304 (OBSS for STA 1302). In another embodiment, the first indication (or another separate indication in frame 2102) may indicate whether pre-emption of OBSS frame 2102 by another STA is allowed. In an embodiment, STA 1304 may set the first indication to 0 when pre-emption of OBSS frame 2102 by another STA is allowed. In an embodiment, when the first indication is set to 0, the other STA may transmit a frame (e.g., a frame shorter than a pre-defined length) during the transmission of OBSS frame 2102. In an embodiment, STA 1304 may set the first indication to 1 when pre-emption of OBSS frame 2102 by another STA is not allowed. In an embodiment, when the first indication is set to 1, the other STA may not transmit a (short) frame during the transmission of OBSS frame 2102.

In an embodiment, as illustrated in FIG. 21, when the first indication is set to 1, OBSS frame 2102 may further include a second indication of a start time of a portion of the OBSS frame 2102 containing the LS traffic; and/or a third indication of a duration of the portion of OBSS frame 2102 containing the LS traffic. In an embodiment, if the LS traffic is contained in a single MPDU within OBSS frame 2102, the start time refers to the start time of the single MPDU containing LS traffic and the duration refers to the duration of the same MPDU. In an embodiment, if the LS traffic is contained in multiple consecutive MPDUs of OBSS frame 2102, the start time refers to the start time of the first occurring MPDU containing LS traffic and the duration refers to the total duration of the multiple consecutive MPDUs. In an embodiment, if the LS traffic is contained in multiple non-consecutive MPDUs of OBSS frame 2102, the start time refers to the start time of the first occurring MPDU containing LS traffic and the duration refers to the duration from the first occurring MPDU containing LS traffic to the last occurring MPDU containing LS traffic of the multiple non-consecutive MPDUs. In another embodiment, multiple second indications and/or multiple third indications may be provided in OBSS frame 2102 in the case of multiple non-consecutive MPDUs containing LS traffic in OBSS frame 2102.

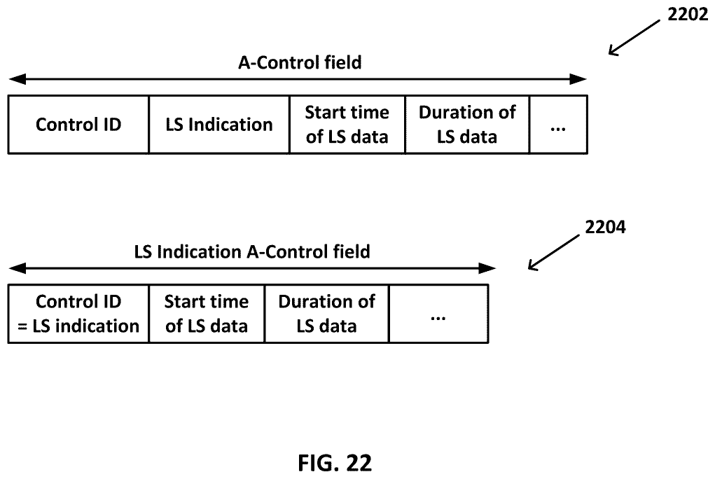

In an embodiment, as shown in FIG. 21, the first indication, the second indication(s), and/or the third indication(s) may be provided in a MAC header of OBSS frame 1902. In an embodiment, the first indication, the second indication(s), and/or the third indication(s) may be provided in the MAC header of a first occurring MPDU (e.g., MPDU #1) of OBSS frame 2102. However, embodiments are not limited as such and the first indication, the second indication(s), and/or the third indication(s) may be provided in the MAC header of any MPDU of OBSS frame 2102. In an embodiment, OBSS frame 2102 may comprise a UHR PPDU. In an embodiment, the first indication, the second indication(s), and/or the third indication(s) may be provided in an Aggregated Control (A-Control) field or an LS indication A-Control field of a MAC header of the UHR PPDU. The A-Control field or the LS indication A-Control field may be provided in a control field (e.g., QoS Control field or UHR Control field) of the MAC header of the UHR PPDU. In an example, the A-Control field may have the format of example A-Control field 2202 shown in FIG. 22. As shown, the A-Control field may include an LS indication subfield in which the first indication may be provided, a start time subfield in which the second indication may be provided, and a duration subfield in which the third indication may be provided. In an example, the LS indication A-Control may have the format of example LS indication A-Control field 2204 shown in FIG. 22. As shown, LS indication A-Control field includes a Control ID subfield which may be used to provide the first indication, a start time subfield in which the second indication may be provided, and a duration subfield in which the third indication may be provided. In an embodiment, when the first indication is set to 0, the second indication and the third indication may be set to a pre-determined value (e.g., 0). An advantage of having the first indication, the second indication, and the third indication in the MAC header of frame 2102 is that the MAC header, unlike the PHY header, may be readily extended to include the indications. This is particularly true when more than one second indication and/or more than one third indication are included in frame 2102.

Returning to FIG. 21, STA 1302 detects the transmission of OBSS frame 2102. For example, STA 1302 may detect a PHY preamble of OBSS frame 2102. Upon detecting OBSS frame 2102, STA 1302 may decode a portion of OBSS frame 2102 to retrieve the first indication from OBSS frame 2102. In an embodiment, STA 1302 may decode the MAC header of an MPDU (e.g., MPDU #1) of OBSS frame 2102. In an embodiment, OBSS frame 2102 may be a UHR PPDU. STA 1302 may decode an A-Control field or an LS indication A-Control field of the MAC header of the UHR PPDU to retrieve the first indication. In an embodiment, where the first indication is set to 1 in OBSS frame 2102, STA 1302 further decodes a portion of the MAC header of OBSS frame 2102 to retrieve the second indication and/or the third indication. In an embodiment, OBSS frame 2102 may be a UHR PPDU. STA 1302 may decode an A-Control field or an LS indication A-Control field of the MAC header of the UHR PPDU to retrieve the second indication and/or the third indication.

In example 2100, data may become available for transmission at STA 1302 while STA 1304 is still transmitting OBSS frame 2102. In an example, the data becoming available at STA 1302 may include latency sensitive data that requires transmission within a short delay (e.g., less than 100 microseconds). In another example, the data becoming available at STA 1302 may be of a small size (e.g., less than 20 microseconds long).

In an embodiment, to transmit the data becoming available for transmission, STA 1302 may access the channel to transmit a frame containing the data based on the first indication obtained from OBSS frame 2102. In an embodiment, if the first indication indicates that OBSS frame 2102 does not contain LS traffic or if the first indication indicates that pre-emption of OBSS frame 2102 by another STA is allowed, STA 1302 accesses the channel to transmit the frame without consideration of overlap of the frame with OBSS frame 2102. In an embodiment, if the first indication indicates that OBSS frame 2102 contains LS traffic or if the first indication indicates that pre-emption of OBSS frame 1902 by another STA is not allowed, STA 1302 accesses the channel to transmit the frame with consideration of overlap of the frame with OBSS frame 2102.

In an embodiment, STA 1302 may only access the channel to transmit the frame based on the first indication on condition that the data available for transmission includes latency sensitive data and/or is shorter than a pre-determined size. That is, if the data becoming available for transmission is not latency sensitive and/or shorter than a pre-determined size, STA 1302 may not use the above-described operation based on the first indication. Instead, STA 1302 may utilize an existing procedure as described above in FIG. 8 for example, which may include waiting for an end of the transmission of OBSS frame 1306 before contending to access the channel.

In an embodiment, accessing the channel without consideration of overlap of the frame with the transmission of OBSS frame 2102 may include STA 1302 immediately transmitting the frame on the channel without contending for channel access. In another embodiment, STA 1302 may still contend for the channel (ignoring OBSS frame 2102) before transmitting the frame.

In an embodiment, accessing the channel to transmit the frame with consideration of overlap of the frame with OBSS frame 2102 comprises accessing the channel to transmit the frame after an end of transmission of OBSS frame 2102. In an embodiment, accessing the channel to transmit the frame with consideration of overlap of the frame with OBSS frame 2102 comprises accessing the channel to transmit the frame at a time that avoids overlap with a portion of OBSS frame 2102 containing LS traffic.

In an embodiment, accessing the channel to transmit the frame at a time that avoids overlap with the portion of OBSS frame 2102 containing LS traffic comprises determining a time to transmit the frame based on the start time and/or the duration of the portion of the OBSS frame 2102 containing LS traffic. In an embodiment, accessing the channel to transmit the frame at a time that avoids overlap with the portion of OBSS frame 2102 containing LS traffic comprises accessing the channel to transmit the frame before or after transmission of the portion of OBSS frame 2102 containing LS traffic. In an embodiment, the frame containing the data becoming available for transmission may not be transmitted without overlapping with the portion of OBSS frame 2102 containing LS traffic. In such an embodiment, STA 1302 may transmit the frame only when the data becoming available for transmission includes latency sensitive data and/or is shorter than a pre-determined size.

In example 2100, the first indication in OBSS frame 2102 is set to 1 indicating presence of LS traffic in OBSS frame 2102 or disallowance of preemption of OBSS frame 2102 by another STA. Further, OBSS frame 2102 may include the second indication and/or the third indication indicating respectively the start time and/or duration of the portion of OBSS frame 2102 containing LS traffic. In example 2100, it is assumed that this portion corresponds to MPDU #2 only. Based on the first indication being set to 1, STA 1302 retrieves the second indication and/or the third indication from OBSS frame 2102. Using the second indication and/or the third indication, STA 1302 determines that the LS traffic may be transmitted without overlapping MPDU #2. Accordingly, STA 1302 begins to transmit a frame 2104 containing the data becoming available for transmission after transmission of MPDU #2 has ended. In an embodiment, STA 1302 may transmit frame 2104 immediately after the transmission of MPDU #2 has ended. In an embodiment, STA 1302 may not contend for channel access before transmitting frame 2104. In another embodiment, STA 1302 may still contend for the channel (ignoring OBSS frame 2102) before transmitting frame 2104.

In example 2100, frame 2104 may overlap with a portion of MPDU #3 of OBSS frame 2102. This overlap may cause reception failure of MPDU #3 at a target STA of OBSS frame 2102. The target STA may respond to frame 2102 by transmitting a BA frame 2106 comprising a bitmap with the values (1, 1, 0) indicating that MPDU #3 was not successfully received but that MPDUs #1 and #2 were successfully received. In response to BA frame 2106, STA 1302 may retransmit MPDU #3 in a subsequent frame 2108 to the target STA.

As shown, the reception of MPDU #3 by the target STA may be delayed in example 2100. However, as MPDU #3 does not contain latency sensitive data (based on the second indication and/or the third indication), the delay of MPDU #3 may be tolerated by the target STA. In return, however, the transmission delay of frame 2104 is significantly reduced, which is particularly beneficial when frame 2104 contains latency sensitive data.

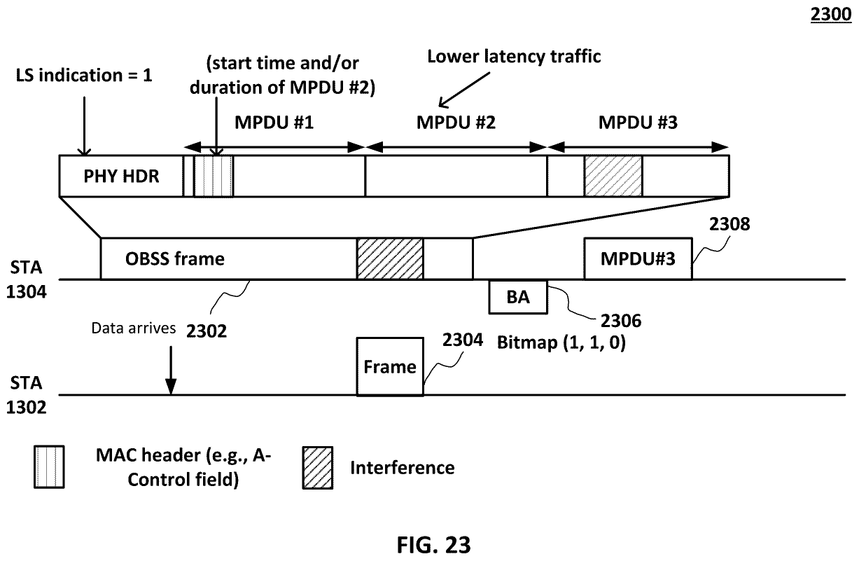

FIG. 23 is an example 2300 illustrates another example operation mode which may be used by a STA in the presence of an OBSS transmission according to an embodiment. As in example 1300, example 1900 also includes STA 1302 and STA 1304 described above.

As shown in FIG. 23, STA 1304 may access the channel and start to transmit an OBSS frame 2302. In an example, OBSS frame 2302 may include one or more MPDUs (e.g., MPDU #1, MPDU #2, and MPDU #3). In an embodiment, OBSS frame 2302 may include a first indication that indicates whether OBSS frame 2302 contains LS traffic. In an embodiment, STA 1304 may set the first indication to 1 when at least one of the one or more MPDUs contains LS traffic. In an embodiment, STA 1304 may set the first indication to 0 when none of the one or more MPDUs contains LS traffic. In an embodiment, LS traffic comprises traffic associated with a traffic identifier (TID) designated as latency sensitive in the BSS of STA 1304 (OBSS for STA 1302). In another embodiment, the first indication (or another separate indication in frame 2302) may indicate whether pre-emption of OBSS frame 2302 by another STA is allowed. In an embodiment, STA 1304 may set the first indication to 0 when pre-emption of OBSS frame 2302 by another STA is allowed. In an embodiment, when the first indication is set to 0, the other STA may transmit a frame (e.g., a frame shorter than a pre-defined length) during the transmission of OBSS frame 2302. In an embodiment, STA 1304 may set the first indication to 1 when pre-emption of OBSS frame 2302 by another STA is not allowed. In an embodiment, when the first indication is set to 1, the other STA may not transmit a (short) frame during the transmission of OBSS frame 2302.

In an embodiment, as illustrated in FIG. 23, when the first indication is set to 1, OBSS frame 2302 may further include a second indication of a start time of a portion of the OBSS frame 2302 containing the LS traffic; and/or a third indication of a duration of the portion of OBSS frame 2302 containing the LS traffic. In an embodiment, if the LS traffic is contained in a single MPDU within OBSS frame 2302, the start time refers to the start time of the single MPDU containing LS traffic and the duration refers to the duration of the same MPDU. In an embodiment, if the LS traffic is contained in multiple consecutive MPDUs of OBSS frame 2302, the start time refers to the start time of the first occurring MPDU containing LS traffic and the duration refers to the total duration of the multiple consecutive MPDUs. In an embodiment, if the LS traffic is contained in multiple non-consecutive MPDUs of OBSS frame 2302, the start time refers to the start time of the first occurring MPDU containing LS traffic and the duration refers to the duration from the first occurring MPDU containing LS traffic to the last occurring MPDU containing LS traffic of the multiple non-consecutive MPDUs. In another embodiment, multiple second indications and/or multiple third indications may be provided in OBSS frame 2302 in the case of multiple non-consecutive MPDUs containing LS traffic in OBSS frame 2302.

In an embodiment, as shown in FIG. 23, the first indication may be provided in a PHY header of OBSS frame 2302. In an embodiment, OBSS frame 2302 may comprise a UHR PPDU. FIG. 15 illustrates an example UHR PPDU 1500 which may be used for OBSS frame 2302 in an embodiment. As shown, example UHR PPDU 1500 may include a PHY header and a payload. The PHY header may include a legacy Short Training field (L-STF), a legacy Long Training field (L-LTF), a legacy Signal field (L-SIG), a repeated legacy Signal field (RL-SIG), a Universal Signal field (U-SIG), a UHR Signal field (UHR-SIG), a UHR Short Training field (UHR-STF), and a UHR Long Training field (UHR-LTF). In an embodiment, as shown in FIG. 15, the first indication may be provided in the UHR-SIG of the PHY header of UHR PPDU 1500.

In an embodiment, with the first indication provided in the PHY header of OBSS frame 2302, the second indication(s) and/or the third indication(s) may be provided in the MAC header of a first occurring MPDU (e.g., MPDU #1) of OBSS frame 2302. However, embodiments are not limited as such and the second indication(s) and/or the third indication(s) may be provided in the MAC header of any MPDU of OBSS frame 2302. In an embodiment, OBSS frame 2302 may comprise a UHR PPDU. In an embodiment, the second indication(s) and/or the third indication(s) may be provided in an Aggregated Control (A-Control) field or an LS indication A-Control field of a MAC header of the UHR PPDU. The A-Control field or the LS indication A-Control field may be provided in a control field (e.g., QoS Control field or UHR Control field) of the MAC header of the UHR PPDU. In an example, the A-Control field may have the format of example A-Control field 2202 shown in FIG. 22, modified to not include an LS indication subfield. In an example, the LS indication A-Control may have the format of example LS indication A-Control field 2204 shown in FIG. 22, modified to not include an LS indication in the Control ID subfield. In an embodiment, when the first indication is set to 0, the second indication and the third indication may be set to a pre-determined value (e.g., 0). An advantage of having the first indication in the PHY header of frame 2302, and the second indication and/or the third indication in the MAC header of frame 2302, is that is that STA 1302 may quickly determine whether OBSS frame 2302 contains LS traffic. Based on the first indication, STA 1302 may or may not decode the MAC header of frame 2302. Additionally, including the first indication only in the PHY header of frame 2302 only negligibly increases the signaling overhead of the PHY header of frame 2302.

Returning to FIG. 23, STA 1302 detects the transmission of OBSS frame 2302. For example, STA 1302 may detect a PHY preamble of OBSS frame 2302. Upon detecting OBSS frame 2302, STA 1302 may decode a portion of OBSS frame 2302 to retrieve the first indication from OBSS frame 2302. In an embodiment, STA 1302 may decode a portion of the PHY header of OBSS frame 2302 to retrieve the first indication. In an embodiment, OBSS frame 2302 may be a UHR PPDU. STA 1302 may decode a UHR-SIG of the PHY header of the UHR PPDU to retrieve the first indication. In an embodiment, where the first indication is set to 1 in OBSS frame 2302, STA 1302 further decodes a portion of the MAC header of OBSS frame 2302 to retrieve the second indication and/or the third indication. In an embodiment, OBSS frame 2302 may be a UHR PPDU. STA 1302 may decode an A-Control field or an LS indication A-Control field of the MAC header of the UHR PPDU to retrieve the second indication and/or the third indication.

In example 2300, data may become available for transmission at STA 1302 while STA 1304 is still transmitting OBSS frame 2302. In an example, the data becoming available at STA 1302 may include latency sensitive data that requires transmission within a short delay (e.g., less than 100 microseconds). In another example, the data becoming available at STA 1302 may be of a small size (e.g., less than 20 microseconds long).

In an embodiment, to transmit the data becoming available for transmission, STA 1302 may access the channel to transmit a frame containing the data based on the first indication obtained from OBSS frame 2302. In an embodiment, if the first indication indicates that OBSS frame 2302 does not contain LS traffic or if the first indication indicates that pre-emption of OBSS frame 2302 by another STA is allowed, STA 1302 accesses the channel to transmit the frame without consideration of overlap of the frame with OBSS frame 2302. In an embodiment, if the first indication indicates that OBSS frame 2302 contains LS traffic or if the first indication indicates that pre-emption of OBSS frame 2102 by another STA is not allowed, STA 1302 accesses the channel to transmit the frame with consideration of overlap of the frame with OBSS frame 2302.

In an embodiment, STA 1302 may only access the channel to transmit the frame based on the first indication on condition that the data available for transmission includes latency sensitive data and/or is shorter than a pre-determined size. That is, if the data becoming available for transmission is not latency sensitive and/or shorter than a pre-determined size, STA 1302 may not use the above-described operation based on the first indication. Instead, STA 1302 may utilize an existing procedure as described above in FIG. 8 for example, which may include waiting for an end of the transmission of OBSS frame 2302 before contending to access the channel.

In an embodiment, accessing the channel without consideration of overlap of the frame with the transmission of OBSS frame 2302 may include STA 1302 immediately transmitting the frame on the channel without contending for channel access. In another embodiment, STA 1302 may still contend for the channel (ignoring OBSS frame 2302) before transmitting the frame.

In an embodiment, accessing the channel to transmit the frame with consideration of overlap of the frame with OBSS frame 2302 comprises accessing the channel to transmit the frame after an end of transmission of OBSS frame 2302. In an embodiment, accessing the channel to transmit the frame with consideration of overlap of the frame with OBSS frame 2302 comprises accessing the channel to transmit the frame at a time that avoids overlap with a portion of OBSS frame 2302 containing LS traffic.

In an embodiment, accessing the channel to transmit the frame at a time that avoids overlap with the portion of OBSS frame 2302 containing LS traffic comprises determining a time to transmit the frame based on the start time and/or the duration of the portion of the OBSS frame containing LS traffic. In an embodiment, accessing the channel to transmit the frame at a time that avoids overlap with the portion of OBSS frame 2302 containing LS traffic comprises accessing the channel to transmit the frame before or after transmission of the portion of the OBSS frame 2302 containing LS traffic. In an embodiment, the frame containing the data becoming available for transmission may not be transmitted without overlapping with the portion of OBSS frame 2302 containing LS traffic. In such an embodiment, STA 1302 may transmit the frame only when the data becoming available for transmission includes latency sensitive data and/or is shorter than a pre-determined size.

In example 2300, the first indication in OBSS frame 2302 is set to 1 indicating presence of LS traffic in OBSS frame 2302 or disallowance of preemption of OBSS frame 2302 by another STA. Further, OBSS frame 2302 may include the second indication and/or the third indication indicating respectively the start time and/or duration of the portion of OBSS frame 2302 containing LS traffic. In example 2300, it is assumed that this portion corresponds to MPDU #2 only. Based on the first indication being set to 1, STA 1302 retrieves the second indication and/or the third indication from OBSS frame 2302. Using the second indication and/or the third indication, STA 1302 determines that the LS traffic may be transmitted without overlapping MPDU #2. Accordingly, STA 1302 begins to transmit a frame 2304 containing the data becoming available for transmission after transmission of MPDU #2 has ended. In an embodiment, STA 1302 may transmit frame 2304 immediately after the transmission of MPDU #2 has ended. In an embodiment, STA 1302 may not contend for channel access before transmitting frame 2304. In another embodiment, STA 1302 may still contend for the channel (ignoring OBSS frame 2102) before transmitting frame 2304.

In example 2300, frame 2304 may overlap with a portion of MPDU #3 of OBSS frame 2302. This overlap may cause reception failure of MPDU #3 at a target STA of OBSS frame 2302. The target STA may respond to frame 2302 by transmitting a BA frame 2306 comprising a bitmap with the values (1, 1, 0) indicating that MPDU #3 was not successfully received but that MPDUs #1 and #2 were successfully received. In response to BA frame 2306, STA 1302 may retransmit MPDU #3 in a subsequent frame 2308 to the target STA.

As shown, the reception of MPDU #3 by the target STA may be delayed in example 2300. However, as MPDU #3 does not contain latency sensitive data (based on the second indication and/or the third indication), the delay of MPDU #3 may be tolerated by the target STA. In return, however, the transmission delay of frame 2304 is significantly reduced, which is particularly beneficial when frame 2304 contains latency sensitive data.

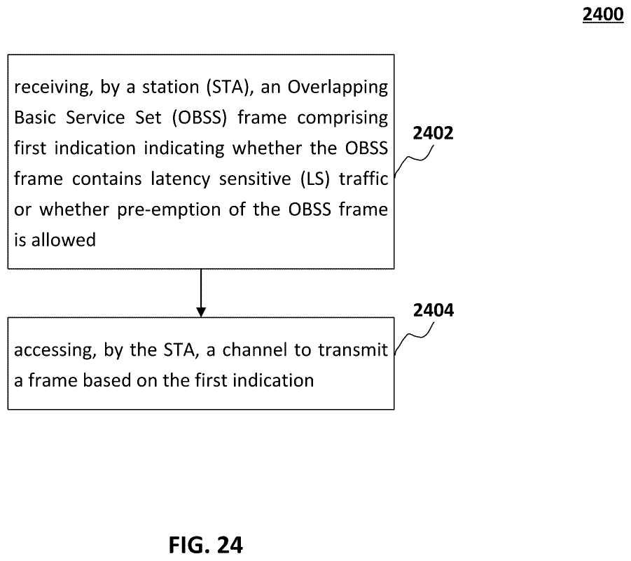

FIG. 24 illustrates an example process 2400 according to an embodiment. Example process 2400 is provided for the purpose of illustration only and is not limiting of embodiments. Example process 2400 may be performed by a STA, such as STA 1302, for example. As shown in FIG. 24, process 2400 includes steps 2402 and 2404. The STA may be an AP STA or a non-AP STA.

In step 2402, process 2400 may include receiving, by the STA, an OBSS frame comprising a first indication indicating whether the OBSS frame contains LS traffic or whether pre-emption of the OBSS frame by another STA is allowed. The OBSS frame may be transmitted by a STA of an OBSS. In an embodiment, the LS traffic comprises traffic associated with a TID designated as latency sensitive in the OBSS.

In an embodiment, process 2400 may further comprise decoding a portion of the OBSS frame to retrieve the first indication. In an embodiment, the portion of the OBSS frame comprises a portion of a PHY header of the OBSS frame. In an embodiment, the portion of the PHY header comprises the first indication. In an embodiment, the frame comprises a UHR PPDU. In an embodiment, the UHR PPDU comprises a UHR-SIG, and the UHR-SIG comprises the first indication.

In another embodiment, the portion of the OBSS frame comprises a portion of a MAC header of the OBSS frame. In an embodiment, the portion of the MAC header comprises the first indication. In an embodiment, the portion of the MAC header comprises an A-Control field, and the A-Control field comprises the first indication. In an embodiment, the OBSS frame comprises a plurality of MPDUs, and the MAC header corresponds to a MAC header of a first occurring MPDU of the plurality of MPDUs.

In an embodiment, where the first indication indicates that the OBSS frame contains LS traffic, the OBSS frame may further comprise: a second indication of a start time of a portion of the OBSS frame containing LS traffic; and a third indication of a duration of the portion of the OBSS frame containing LS traffic.

In an embodiment, the first indication, the second indication, and the third indication are provided in a PHY header of the OBSS frame. In an embodiment, the OBSS frame comprises a UHR PPDU, and the first indication, the second indication, and the third indication are provided in a UHR-SIG of the UHR PPDU.

In an embodiment, the first indication is provided in a PHY header of the OBSS frame, and the second indication and the third indication are provided in a MAC header of the OBSS frame. In an embodiment, the OBSS frame comprises a UHR PPDU. The first indication may be provided in a UHR-SIG of the UHR PPDU and the second indication and the third indication may be provided in A-Control field of the MAC header of the OBSS frame.

In an embodiment, the first indication, the second indication, and the third indication are provided in a MAC header of the OBSS frame. In an embodiment, the OBSS frame comprises a UHR PPDU. The first indication, the second indication, and the third indication may be provided in A-Control field of the MAC header of the OBSS frame. In an embodiment, the OBSS frame comprises a plurality of MPDUs, and the MAC header corresponds to a MAC header of a first occurring MPDU of the plurality of MPDUs.

In step 2404, process 2400 may include accessing, by the STA, a channel to transmit a frame based on the first indication.

In an embodiment, accessing the channel to transmit the frame based on the first indication comprises: if the first indication indicates that the OBSS frame does not contain LS traffic or that pre-emption of the OBSS frame by another STA is allowed, accessing the channel to transmit the frame without consideration of overlap of the frame with the OBSS frame.

In an embodiment, accessing the channel to transmit the frame based on the first indication comprises: if the first indication indicates that the OBSS frame contains LS traffic or that pre-emption of the OBSS frame by another STA is not allowed, accessing the channel to transmit the frame with consideration of overlap of the frame with the OBSS frame.

In an embodiment, accessing the channel to transmit the frame with consideration of overlap of the frame with the OBSS frame comprises accessing the channel to transmit the frame after an end of transmission of the OBSS frame.

In an embodiment, accessing the channel to transmit the frame with consideration of overlap of the frame with the OBSS frame comprises accessing the channel to transmit the frame at a time that avoids overlap with a portion of the OBSS frame containing LS traffic. In an embodiment, accessing the channel to transmit the frame at a time that avoids overlap with the portion of the OBSS frame containing LS traffic comprises determining the time to transmit the frame based on the start time and/or the duration of the portion of the OBSS frame containing LS traffic. In an embodiment, accessing the channel to transmit the frame at a time that avoids overlap with the portion of the OBSS frame containing LS traffic comprises accessing the channel to transmit the frame before or after transmission of the portion of the OBSS frame containing LS traffic.

In an embodiment, accessing the channel to transmit the frame based on the first indication further comprises accessing the channel to transmit the frame on condition that the frame contains LS traffic.

In an embodiment, accessing the channel to transmit the frame based on the first indication may comprise accessing the channel to transmit the frame without contending for the channel. In another embodiment, accessing the channel to transmit the frame based on the first indication may comprise contending for access to the channel.

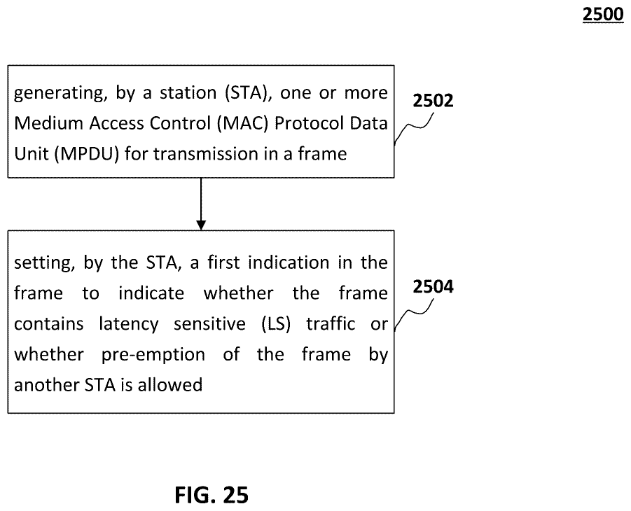

FIG. 25 illustrates an example process 2500 according to an embodiment. Example process 2500 is provided for the purpose of illustration only and is not limiting of embodiments. Example process 2500 may be performed by a STA, such as STA 1304, for example. As shown in FIG. 25, process 2500 includes steps 2502 and 2504. The STA may be an AP STA or a non-AP STA.

In step 2502, process 2500 may include generating, by a station (STA), one or more MPDU for transmission in a frame.

In step 2504, process 2500 may include setting, by the STA, a first indication in the frame to indicate whether the frame contains LS traffic or whether pre-emption of the frame by another STA is allowed.

In an embodiment, step 2504 further includes setting the first indication to 1 when at least one of the one or more MPDU contains LS traffic; and setting the first indication to 0 when none of the one or more MPDU contain LS traffic. In an embodiment, the LS traffic comprises traffic associated with a TID designated as latency sensitive in a BSS of the STA. In another embodiment, step 2504 further includes setting the first indication to 1 when pre-emption of the frame by another STA is not allowed; and setting the first indication to 0 when pre-emption of the frame by another STA is allowed.

In an embodiment, the frame comprises a UHR PPDU. In an embodiment, the first indication is provided in a PHY header of the UHR PPDU. In an embodiment, the first indication is provided in a UHR-SIG of the PHY header of the UHR PPDU. In an embodiment, the first indication is provided in a MAC header of the UHR PPDU. In an embodiment, the first indication is provided in an A-Control field of the MAC header of the UHR PPDU. In an embodiment, the UHR PPDU comprises a plurality of MPDUs, and the MAC header corresponds to a MAC header of a first occurring MPDU of the plurality of MPDUs.

In an embodiment, where the first indication indicates whether the frame contains LS traffic and is set to 1, step 2504 may further comprise setting in the frame one or more of: a second indication of a start time of a portion of the frame containing the LS traffic; and a third indication of a duration of the portion of the frame containing the LS traffic.

In an embodiment, the first indication, the second indication, and the third indication are provided in a PHY header of the frame. In an embodiment, the first indication, the second indication, and the third indication are provided in a UHR-SIG of the PHY header of the frame.

In another embodiment, the first indication is provided in a PHY header of the frame, and the second indication and the third indication are provided in a MAC header of the frame. In an embodiment, the first indication is provided in a UHR-SIG of the PHY header of the frame, and the second indication and the third indication are provided in an A-Control field of the MAC header of the frame.

In another embodiment, the first indication, the second indication, and the third indication are provided in a MAC header of the OBSS frame. In an embodiment, the first indication, the second indication, and the third indication are provided in an A-Control field of the MAC header of the frame.

What is claimed is:

1. A station (STA) comprising:
one or more processors; and
memory storing instructions that, when executed by the one or more processors of the STA, cause the STA to:
receive, via a channel, an overlapping basic service set (OBSS) physical layer protocol data unit (PPDU) comprising a first indication of whether the OBSS PPDU contains latency sensitive (LS) traffic or whether pre-emption of the OBSS PPDU is allowed; and
access the channel to transmit a PPDU, based on the first indication.

2. The STA of claim 1, wherein the instructions, when executed by the one or more processors, further cause the STA to access the channel to transmit the PPDU without consideration of overlap of the PPDU with the OBSS PPDU, based on the first indication indicating that the OBSS PPDU does not contain LS traffic or that pre-emption of the OBSS PPDU is allowed.

3. The STA of claim 2, wherein the instructions, when executed by the one or more processors, further cause the STA to access the channel to transmit the PPDU on condition that the PPDU contains LS traffic.

4. The STA of claim 2, wherein the instructions, when executed by the one or more processors, further cause the STA to access the channel to transmit the PPDU with consideration of overlap of the PPDU with the OBSS PPDU, based on the first indication indicating that the OBSS PPDU contains LS traffic or that pre-emption of the OBSS PPDU is not allowed.

5. The STA of claim 4, wherein the instructions, when executed by the one or more processors, further cause the STA to access the channel to transmit the PPDU after an end of transmission of the OBSS PPDU.

6. The STA of claim 4, wherein the instructions, when executed by the one or more processors, further cause the STA to access the channel to transmit the PPDU at a time that avoids overlap with a portion of the OBSS PPDU containing LS traffic.

7. The STA of claim 1, wherein the first indication indicates that the OBSS PPDU contains LS traffic, the OBSS PPDU further comprising one or more of:
a second indication of a start time of a portion of the OBSS PPDU containing LS traffic; and
a third indication of a duration of the portion of the OBSS PPDU containing LS traffic.

8. The STA of claim 1, wherein the instructions, when executed by the one or more processors, further cause the STA to access the channel to transmit the PPDU without contending for the channel.

9. The STA of claim 1, wherein the instructions, when executed by the one or more processors, further cause the STA to contend for access to the channel to transmit the PPDU.

10. A station (STA) comprising:
one or more processors; and
memory storing instructions that, when executed by the one or more processors of the STA, cause the STA to:
generate one or more Medium Access Control (MAC) Protocol Data Unit (MPDU) for transmission in a physical protocol data unit (PPDU);
set a first indication in the PPDU to indicate whether the PPDU contains latency sensitive (LS) traffic or whether pre-emption of the PPDU is allowed; and
transmit the PPDU comprising the first indication,
wherein the instructions, when executed by the one or more processors, further cause the STA to:
set the first indication to 1:
when the first indication indicates whether the PPDU contains LS traffic and when at least one of the one or more MPDU contains LS traffic; or
when the first indication indicates whether pre-emption of the PPDU is allowed and when pre-emption of the PPDU is not allowed; and
set the first indication to 0:
when the first indication indicates whether the PPDU contains LS traffic and when none of the one or more MPDU contain LS traffic; or
when the first indication indicates whether pre-emption of the PPDU is allowed and when pre-emption of the PPDU is allowed.

11. The STA of claim 10, wherein the first indication is provided in a physical layer (PHY) header or in a Medium Access Control (MAC) header of the PPDU.

12. The STA of claim 11, wherein the PPDU comprises a plurality of MPDUs, and wherein the MAC header corresponds to a MAC header of a first occurring MPDU of the plurality of MPDUs.

13. The STA of claim 10, wherein the first indication indicates whether the PPDU contains LS traffic, and wherein the instructions, when executed by the one or more processors, further cause the STA to set in the PPDU one or more of:
a second indication of a start time of a portion of the PPDU containing the LS traffic; and
a third indication of a duration of the portion of the PPDU containing the LS traffic.

14. The STA of claim 13, wherein the first indication, the second indication, and the third indication are provided in a physical layer (PHY) header or in a Medium Access Control (MAC) header of the PPDU.

15. A non-transitory computer-readable medium comprising instructions that, when executed by one or more processors of a station (STA), cause the STA to:
receive, via a channel, an overlapping basic service set (OBSS) physical layer protocol data unit (PPDU) comprising a first indication of whether the OBSS PPDU contains latency sensitive (LS) traffic or whether pre-emption of the OBSS PPDU is allowed; and
access the channel to transmit a PPDU, based on the first indication.

16. The non-transitory computer-readable medium of claim 15, wherein the instructions, when executed by the one or more processors, further cause the STA to access the channel to transmit the PPDU without consideration of overlap of the PPDU with the OBSS PPDU, based on the first indication indicating that the OBSS PPDU does not contain LS traffic or that pre-emption of the OBSS PPDU is allowed.

17. The non-transitory computer-readable medium of claim 16, wherein the instructions, when executed by the one or more processors, further cause the STA to access the channel to transmit the PPDU on condition that the PPDU contains LS traffic.

18. The non-transitory computer-readable medium of claim 16, wherein the instructions, when executed by the one or more processors, further cause the STA to access the channel to transmit the PPDU with consideration of overlap of the PPDU with the OBSS PPDU, based on the first indication indicating that the OBSS PPDU contains LS traffic or that pre-emption of the OBSS PPDU is not allowed.

19. The non-transitory computer-readable medium of claim 18, wherein the instructions, when executed by the one or more processors, further cause the STA to access the channel to transmit the PPDU after an end of transmission of the OBSS PPDU.

20. The non-transitory computer-readable medium of claim 18, wherein the instructions, when executed by the one or more processors, further cause the STA to access the channel to transmit the PPDU at a time that avoids overlap with a portion of the OBSS PPDU containing LS traffic.
